(19) United States
(12) Patent Application Publication
(10) Pub. No.: US 2012/0102284 A1
(43) Pub. Date: Apr. 26, 2012

(54) METHOD FOR DETECTING ACCESS TO OBJECT, AND COMPUTER AND COMPUTER PROGRAM PRODUCT FOR THE SAME

(75) Inventor: Rei Odaira, Yamato (JP)

(73) Assignee: International Business Machines Corporation, Armonk, NY (US)

(21) Appl. No.: 13/274,981

(22) Filed: Oct. 17, 2011

(30) Foreign Application Priority Data
Oct. 20, 2010 (JP) 2010-235841

(51) Int. Cl. G06F 12/14

(52) U.S. Cl. 711/163; 711/E12.098

(57) ABSTRACT

A method for detecting access to an object, and a computer and a computer program product including steps and components for converting an original pointer to the object into a pointer pointing to a read-write-protected area by manipulating the original pointer and a step of reversely converting the converted pointer into the original pointer using occurrence of an exception in response to a request to access the read-write-protected area. Additionally, the step of reversely converting may include a step of acquiring, with reference to an instruction that has caused the exception, the manipulated pointer from the instruction that has caused the exception and a step of reversely converting the acquired pointer and acquiring a pointer to a head of the object pointed to by the reversely converted original pointer.

### TECHNICAL FIELD

The present invention relates to techniques for detecting access to an object kept in a memory of a computer and, more particularly to, a technique for detecting access to an object having a modified object format.

### BACKGROUND OF THE INVENTION

In many programs, many objects are dynamically allocated in a heap area of a memory. Formats of the objects are fixed in implementations of, for example, present Java (trademark) virtual machines throughout execution of programs. The fixed object formats include layout of a header and data fields and sizes thereof, for example. Meanwhile, a decrease in a memory footprint (an amount of memory to be used), a memory bandwidth, cache misses, frequency of garbage collection (GC), and GC overhead is effective in reducing cost of computers that execute the programs. Accordingly, many object formats (hereinafter, also referred to as “modified object formats”) that can be applied to the programs have been developed by modifying the fixed object formats (hereinafter, referred to as “ordinary object formats” or “original object formats”) into a form that can reduce the cost (see FIG. 4 to FIG. 6 below).

When an object format is modified from an ordinary one, the object format has to be checked in every access. However, checking the object format in every access produces runtime overhead and is disadvantageous with regard to costs of systems.

Additionally, when the object format is modified from the ordinary one, a page including an object having the modified object format has to be protected. For this reason, all objects (including the object having the modified format) included in the page have to be recovered at the time of recovery of the object having the modified format (see FIG. 8). Additionally, hardware support is needed in another example of the protection.

An approach described in Japanese Unexamined Patent Application Publication No. 2010-015223 relates to a method for effectively using a memory area by isolating objects, existing in the memory area, that have not been accessed for a certain period and, more particularly, to a method for isolating objects existing in a heap memory (paragraph 0001). The patent publication teaches that, if there is access to a semi-inaccessible area from a user program, control is shifted to a signal handler. Since the signal handler can acquire an accessed virtual memory address, the signal handler identifies an object and sets an access flag. At the time of the next GC, an object with the set access flag is returned to an ordinary heap memory area and the flag is cleared.

An approach detailed in Japanese Unexamined Patent Application Publication No. 2000-066904 relates to a multi-task control method for enabling multi-task processing and a storage medium (paragraph 0001). As taught therein, when an event such as an interrupt signal, occurs, a signal handler detects occurrence of interruption and notifies a super signal thread of occurrence of the interrupt event.

### SUMMARY OF INVENTION

The present invention provides a method for detecting access to an object, and a computer program product and a computer for the same. The present invention comprises steps and means for converting an original pointer into a pointer pointing to a read-write-protected area by manipulating the original pointer and converting the converted pointer into the original pointer using occurrence of an exception in response to a request to access the read-write-protected area. Since the original pointer is recovered by the reverse conversion, it is possible to detect the object pointed to by the original pointer and to access the object pointed to by the original pointer.

Additionally, in one embodiment of the present invention, the reverse conversion includes acquiring the manipulated pointer from an instruction that has caused the exception with reference to the instruction that has caused the exception, reversely converting the acquired pointer, and acquiring a pointer to a head of the object pointed to by the reversely converted original pointer. Acquisition of the pointer to the head of the object pointed to by the reversely converted original pointer makes it possible to detect the object pointed to by the original pointer and to access the object pointed to by the original pointer.

In addition, in still another embodiment of the present invention, with reference to header information of the object pointed to by the reversely converted original pointer, processing may be performed which is suitable for a format of the object pointed to by the reversely converted original pointer (which is also the object having the header information that is referred to). The processing may be, for example, decompression of a compressed object to be accessed or lazy allocation of an object to be accessed.

In accordance with the embodiments of the present invention, it is possible to efficiently perform access to an object accessed by an original pointer since the original pointer is recovered using occurrence of an exception in response to a request to access a read-write-protected area. Additionally, in accordance with the embodiments of the present invention, since a pointer to a head of the object pointed to by the reversely converted original pointer can be acquired, it is possible to easily detect the object pointed to by the original pointer. Further, in accordance with the embodiments of the present invention, since processing suitable for a format of the object having the header information that is referred to is performed with reference to header information of the object pointed to by the reversely converted original pointer, it is possible to easily access the object having the different format even when the object format is modified from the ordinary one. This makes it possible to adopt a format using an amount of memory which is less than the ordinary object format and, further, leads to a reduction in cost of a system and/or an improvement of processing speed.

### BRIEF DESCRIPTION OF DRAWINGS

FIG. 1 is a basic block diagram of computer hardware according to an embodiment of the present invention.

FIG. 2 is a functional block diagram of a system having functions of the computer hardware illustrated in FIG. 1 in accordance with an embodiment of the present invention.

FIG. 3 illustrates an example of objects and pointers to the objects.

FIG. 4 illustrates an example of a modified object format into which an ordinary object format is modified by compression.

FIG. 5 illustrates an example of a modified object format into which an ordinary object format is modified by specifying character arrays using pointers.

FIG. 6 illustrates an example of a modified object format into which an ordinary object format is modified by field relocation.

FIG. 7 illustrates a method for accessing an object in a persistent object database system in accordance with the related art.

FIG. 8 illustrates a method for accessing a compressed object in a persistent object database system in accordance with the related art.

FIG. 9A illustrates a method for accessing an object when a pointer is converted into one pointing to a read-write-protected area in accordance with an embodiment of the present invention.

FIG. 9B illustrates a method for accessing an object when a pointer is converted into one pointing to a read-write-protected area in accordance with an embodiment of the present invention.

FIG. 10 illustrates an example of converting a pointer to an object into one pointing to a read-write-protected area in accordance with an embodiment of the present invention.

FIG. 11 illustrates an example of a barrier pointer when a read-write-protected area and a heap area are the same size in accordance with an embodiment of the present invention.

FIG. 12 illustrates an example of a barrier pointer when a read-write-protected area is smaller than a heap area in accordance with an embodiment of the present invention.

FIG. 13 illustrates an example of a barrier pointer when an OS protection area serves as a read-write-protected area in accordance with an embodiment of the present invention.

FIG. 14 illustrates a flowchart of a method for detecting access to an object in accordance with an embodiment of the present invention.

FIG. 15 illustrates a flowchart of an algorithm for processing a memory access exception using a slot storing a pointer value to a head of an object in accordance with an embodiment of the present invention.

FIG. 16 is a flowchart of an algorithm for converting a pointer to an object into one pointing to a read-write-protected area in object allocation in accordance with an embodiment of the present invention.

FIG. 17 illustrates a flowchart of an algorithm for converting a pointer to an object into one pointing to a read-write-protected area in garbage collection in accordance with an embodiment of the present invention.

FIG. 18 illustrates a virtual address space in step 1701 (before starting GC) of FIG. 17 in accordance with an embodiment of the present invention.

FIG. 19 illustrates a virtual address space in step 1703 of FIG. 17 in accordance with an embodiment of the present invention.

FIG. 20 illustrates a virtual address space and contents of an element P and a set S processed in steps 1704 and 1705 of FIG. 17 in accordance with an embodiment of the present invention.

FIG. 21 illustrates a virtual address space and contents of an element P and a set S processed in steps 1707, 1709, and 1710 of FIG. 17 in accordance with an embodiment of the present invention.

FIG. 22 illustrates a virtual address space and contents of an element P and a set S processed in steps 1704, 1705, 1707, 1709, and 1710 of FIG. 17 in accordance with an embodiment of the present invention.

FIG. 23 illustrates a virtual address space and contents of an element P and a set S processed in steps 1704, 1705, 1707 and 1708 of FIG. 17 in accordance with an embodiment of the present invention.

FIG. 24 illustrates a virtual address space and contents of an element P and a set S processed in steps 1708, 1709, 1710, 1704, 1705, 1707, and 1708 of FIG. 17 in accordance with an embodiment of the present invention.

FIG. 25 illustrates a virtual address space and contents of an element P and a set S processed in steps 1709, 1710, 1704, and 1706 of FIG. 17 in accordance with an embodiment of the present invention.

FIG. 26 illustrates an example of an operation for invoking a signal handler and recovering an original pointer from a converted one (reverse conversion) in accordance with an embodiment of the present invention.

FIG. 27 illustrates an example of a signal handler algorithm in accordance with an embodiment of the present invention.

FIG. 28 illustrates a result of an experiment on a relation between object access frequency and overhead in accordance with an embodiment of the present invention.

### DETAILED DESCRIPTION OF THE INVENTION

Embodiments of the present invention will be described below with reference to the accompanying drawings. The same subjects are indicated by identical references throughout the drawings unless otherwise noted. It should be understood that embodiments are merely illustrating preferred embodiments of the present invention and should not be construed as limiting the scope of the present invention.

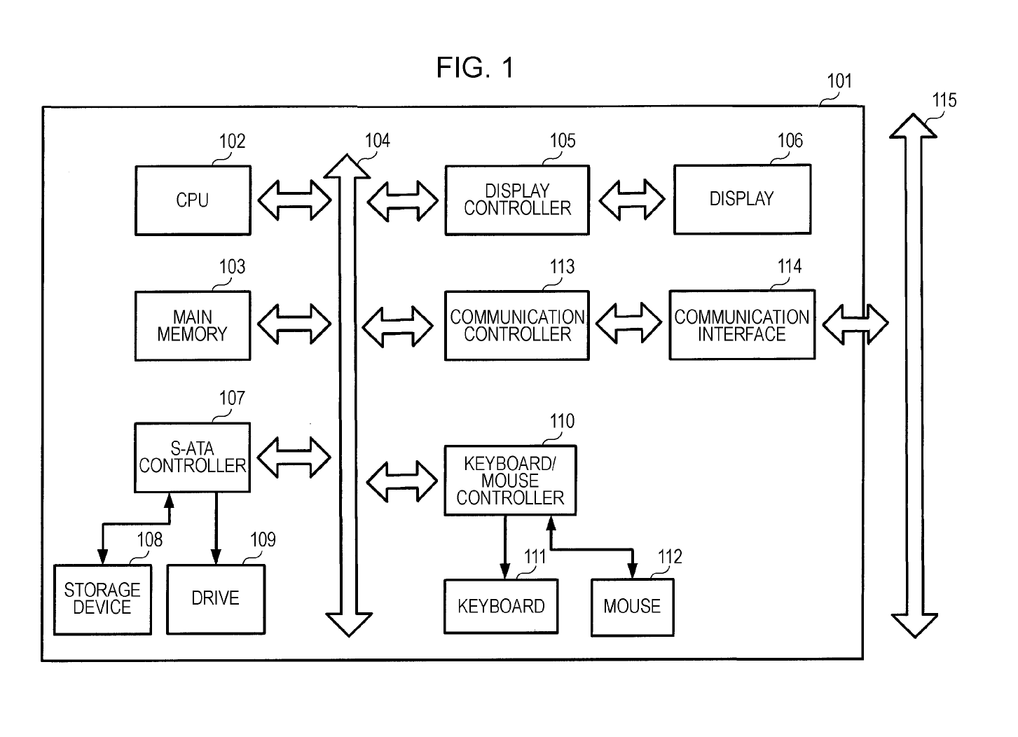

FIG. 1 illustrates a basic block diagram of computer hardware in accordance with an embodiment of the present invention.

A computer (101) includes a CPU (102) and a main memory (103), which are connected to a bus (104). The CPU (102) is preferably based on the 32-bit or 64-bit architecture. For example, the Core i* (* throughout indicates that the name may be a trademark of its respective owner) series, the Core 2* series, the Atom* series, the Xeon* series, the Pentium* series, or the Celeron* series of Intel* Corporation or the Phenom* series, the Athlon* series, the Turion* series, or Sempron* of AMD* can be used. A display (106), e.g., a liquid crystal display (LCD), can be connected to the bus (104) via a display controller (105). The display (106) is used for displaying, for management of the computer, information on a computer connected to a network via a communication network and information on software running on the computer using an appropriate graphic interface. A storage device (108), e.g., a hard disk or a silicon disk, and a drive (109), e.g., a CD drive, a DVD drive, or a BD drive, can be connected to the bus (104) via an S-ATA or IDE controller (107). A keyboard (111) and a mouse (112) can be further connected to the bus (104) via a keyboard/mouse controller (110) or a USB bus (not illustrated).

The storage device (108) stores an operating system, a Java* processing environment such as J2EE*, Java* applications, a Java* virtual machine (VM), programs providing Java* just-in-time (JIT)* compilers, other programs, and data, in a manner that the stored materials can be loaded to the main memory (103).

The drive (109) is used for installing programs from a CD-ROM, a DVD-ROM, or a BD in the storage device (108) as needed.

A communication interface (114) supports, for example, the Ethernet* protocol. The communication interface (114) is connected to the bus (104) via a communication controller (113). The communication interface (114) functions to physically connect the computer (101) to a communication network (115) and provides a network interface layer of the TCP/IP communication protocol of a communication function of the OS of the computer (101). Meanwhile, the communication network (115) may be a wired LAN environment or a wireless LAN environment based on a wireless LAN connection standards, such as IEEE 802.11a/b/g/n.

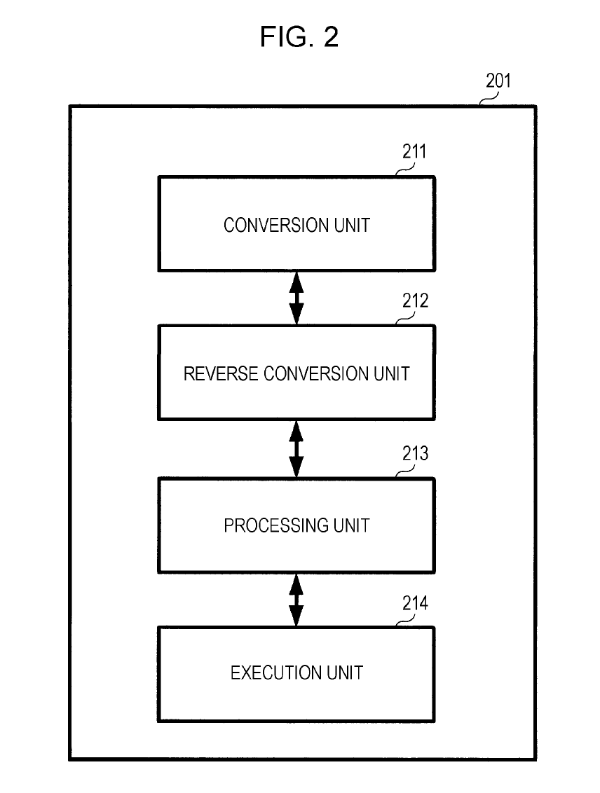

FIG. 2 is a functional block diagram of a computer (201) having the hardware functions of the computer (101) illustrated in FIG. 1 in accordance with an embodiment of the present invention.

In addition to, for example, the CPU (102), the main memory (103) and the storage device (108) illustrated in FIG. 1, the computer (201) includes a conversion unit (211) and a reverse conversion unit (212). The computer (201) may further include a processing unit (213) and an execution unit (214).

The conversion unit (211) manipulates an original pointer to an object to convert the original pointer into a pointer pointing to a read-write-protected area.

In accordance with one embodiment of the present invention, the conversion unit (211) may perform conversion processing as described by any one of the following steps (1) to (3).

(1) A certain offset value is added to the original pointer, so that the pointer pointing to the read-write-protected area (a converted pointer) is acquired.

(2) The original pointer to the object is shifted to the right by n bits (where n is an integer) and a certain offset value is added to the right-shifted pointer, so that the pointer pointing to the read-write-protected area (the converted pointer) is acquired.

(3) The original pointer to the object is shifted to the right by n bits (where n is an integer) and an address of the read-write-protected area is embedded in the empty most-significant bits, so that the pointer pointing to the read-write-protected area (the converted pointer) is acquired.

The conversion unit (211) performs the above conversion, for example, in object allocation or in garbage collection.

The reverse conversion unit (212) reversely converts the converted pointer into the original one using an occurrence of an exception in response to a request to access the read-write-protected area.

In accordance with one embodiment of the present invention, the reverse conversion unit (212) refers to an instruction that has caused the exception, acquires the manipulated pointer from the instruction that has caused the exception, and reversely converts the acquired pointer to acquire a pointer to a head of the object pointed to by the reversely converted original pointer.

In accordance with another embodiment of the present invention, the reverse conversion unit (212) refers to a correspondence table of an instruction address where the exception has occurred and a register or slot number of a slot (also referred to as a pinning array slot) storing a pointer value to a head of an object, acquires the manipulated pointer from the instruction address where the exception has occurred, reversely converts the acquired pointer, and acquires a pointer to the head of the object pointed to by the reversely converted original pointer.

In accordance with still another embodiment of the present invention, the reverse conversion unit (212) may perform reverse conversion processing as described by (1′) to (3′), which correspond to (1) to (3) performed by the conversion unit (211), respectively.

(1′) The certain offset value is subtracted from the pointer converted in (1) described above, so that the original pointer is acquired.

(2′) The certain offset value is subtracted from the pointer converted in (2) described above and the resulting pointer is shifted to the left by n bits, where n is the same as that used in (2), so that the original pointer is acquired.

(3′) The pointer converted in (3) described above is shifted to the left by n bits, where n is the same as that used in (3), so that the original pointer is acquired.

With reference to header information of the object pointed to by the reversely converted original pointer, the processing unit (213) performs processing suitable for a format of the object having the header information that is referred to. The processing suitable for the format may be, for example, decompression of a compressed object or lazy allocation of a character array.

After the processing unit (213) performs the processing suitable for the format, the execution unit (214) accesses the object pointed to by the reversely converted original pointer.

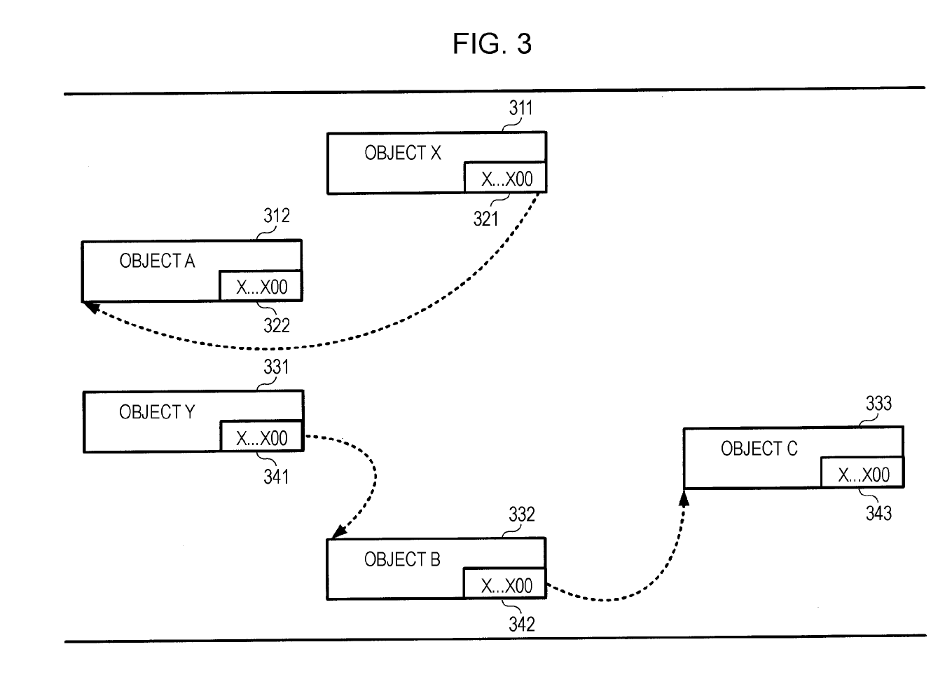

FIG. 3 illustrates an example of objects and pointers to the objects.

An “object” is an entity of an abstract target of a procedure in a program and is generated at an object allocation location written in the program. The “object” is allocated in a memory, e.g., a heap area, during execution of the program. The “object” is generated from, for example, a class. The “object” may exist in the heap area even after execution of the program suspends or completes. Herein, the heap area does not indicate a whole heap area used by a program but is a portion of the whole heap area where objects are allocated. The heap area is, for example, subjected to GC.

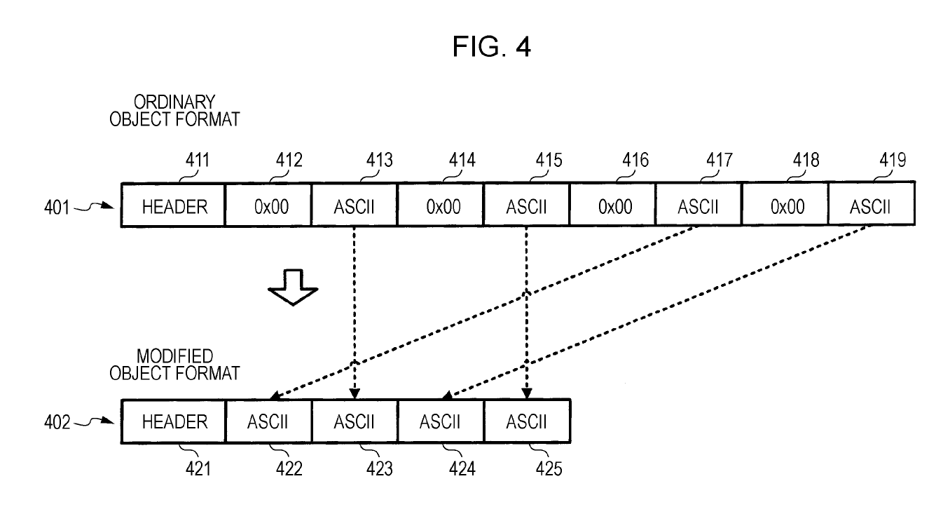

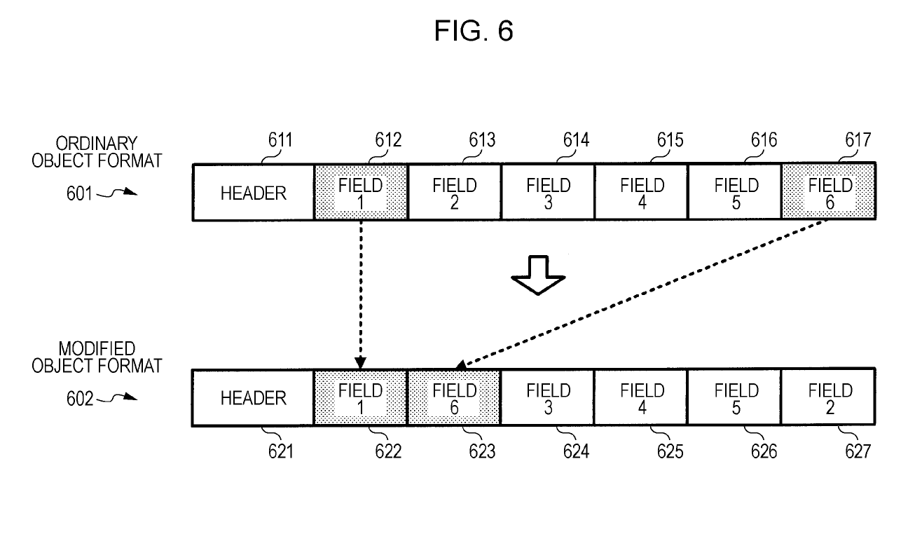

The “object” typically includes a header and at least one field (see FIG. 4 and FIG. 6 below). The header is a part that is embedded in the object and stores information on the object. The header includes, for example, information on size and type of the object. The field is a part that can be accessed by users. The field includes two kinds of data, e.g., a pointer and a non-pointer. The pointer is a value that points to a location in a memory area. In many language processing systems, a pointer to an object refers to a head address of the object (see FIG. 3). The non-pointer includes a numerical value, a character, and/or a true or false value. The value of the non-pointer is utilized in programming.

The “object” is allocated in the memory area. In GC, allocated objects are moved or discarded depending on a circumstance.

Formats of the “object” include a so-called ordinary object format and an object format (hereinafter, also referred to as a “modified object format”) into which the original object format is modified.

The “ordinary object format” is seen in, for example, implementations of Java*, C#, Script* (PHP or Perl)*, Ruby*, C, C++, LISP*, Python*, or Haskell* and indicates a format that is not modified. In Java*, the object format is seen only in implementations of Java* (i.e., in a memory). The ordinary object format differs depending on a class of the object.

The “modified object format” indicates an object format in which the ordinary object format is modified in order to decrease a memory footprint (an amount of memory to be used), a memory bandwidth, cache misses, frequency of garbage collection, and GC overhead. Although FIGS. 4 to 6 illustrate examples of the modified object format, the present invention should not be limited by these modification examples.

An object X (311) includes a pointer (321) therein. The pointer (321) indicates access to an object A (312) and includes a head address of the object A (312). The object A (312) is also a target object of the pointer (321). The object A (312) may have the ordinary object format or the modified object format.

An object Y (331) includes a pointer (341) therein. The pointer (341) indicates access to an object B (332) and includes a head address of the object B (332). The object B (332) is also a target object of the pointer (341). The object B (332) includes a pointer (342) therein. The pointer (342) indicates access to an object C (333) and includes a head address of the object C (333). The object C (333) is also a target object of the pointer (342). As described above, by sequentially reading the pointers, access to another object from the read pointer is further indicated. Each of the object B (332) and the object C (333) may have the ordinary object format or the modified object format.

FIG. 4 illustrates an example of a modified object format into which the ordinary object format is modified by compression.

The modification by compression indicates, for example, that, when a given character array or a character array allocated in a given portion tends to be rarely accessed and the character array includes only ASCII character strings, the character array can be compressed. The compression of the object brings optimization of object access.

An object format (401) indicates the ordinary format. An object format (402) indicates a format obtained when the object format (401) is modified by compression.

The object format (401) includes a header (411), null data fields (412, 414, 416, and 418), and ASCII data fields (413, 415, 417, and 419). The object format (402) includes a header (421) and ASCII data fields (422 to 425).

In the modified object format (402), the null data fields (412, 414, 416, and 418) of the object format (401) are deleted and the ASCII data fields (413, 415, 417, and 419) are combined. Since the numbers of data fields in the modified object format (402) and in the object format (401) are 4 and 8, respectively, the data fields of the modified object format (402) are compressed to half of the data fields of the object format (401). Since the number of data fields is compressed in the modified object format (402), cost of memory can be reduced compared to the object format (401).

Many object compression methods are known.

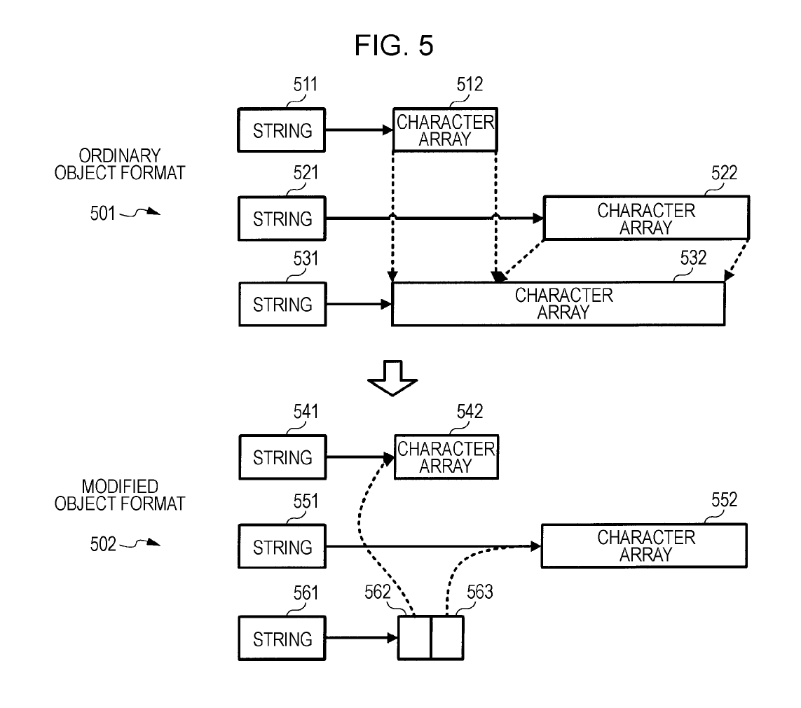

FIG. 5 illustrates a modified object format into which the ordinary object format is modified by specifying character arrays using pointers.

Specification of character arrays using pointers indicates, for example, that, when a plurality of string objects allocated at a given portion tends to be rarely accessed and those string objects are generated by linking other string objects, linkable character arrays can be specified using pointers. Allocation of a character array may occur lazily. Since the object is not allocated until the object is actually needed in lazy allocation, the lazy allocation brings optimization of object access.

An object format (501) indicates the ordinary format. An object format (502) indicates a format modified from the object format (501).

The object format (501) indicates that, when a character array (512) and a character array (522) are allocated in two different locations, the character arrays (512) and (522) are linked together and a character array (532) is newly generated. Generation of the character array (532) may occur lazily. The object format (502) indicates that, when a character array (542) and a character array (552) are allocated in different locations, the character arrays (542) and (552) are specified using two pointers (562 and 563), respectively.

The modified object format (502) differs from the object format (501) in that the modified object format (502) includes the two pointers (562 and 563) instead of the character array (532) of the object format (501). Since the object format (502) includes the two pointers (562 and 563) instead of the character array (532), cost of memory can be reduced.

FIG. 6 illustrates an example of a modified object format into which the ordinary object format is modified by field relocation.

The field relocation indicates, for example, that, when two or more fields in an object tend to be accessed at the same time, the two or more fields are co-located at a single location in order to reduce data cache misses regarding the two or more fields.

An object format (601) indicates the ordinary format. An object format (602) indicates a format modified from the object format (601).

The object format (601) includes a header (611) and data fields (612 to 617) arranged in order of 1-6. The object format (602) includes a header (621) and data fields (622 to 627) arranged in order of 1, 6, 3, 4, 5, and 2.

It is assumed that the data field 1 (612) and the data field 6 (617) tend to be accessed at the same time.

In the object format (601), the data field 1 (612) and the data field 6 (617) that tend to be accessed at the same time exist apart from each other. Accordingly, in the modified object format (602), the format is modified so that the data field 6 (623) is located next to the data field 1 (622). Since the format is modified so that the data field (622) and the data field 6 (623) that tend to be accessed at the same time are located next to each other in the modified object format (602), cost of memory access can be reduced.

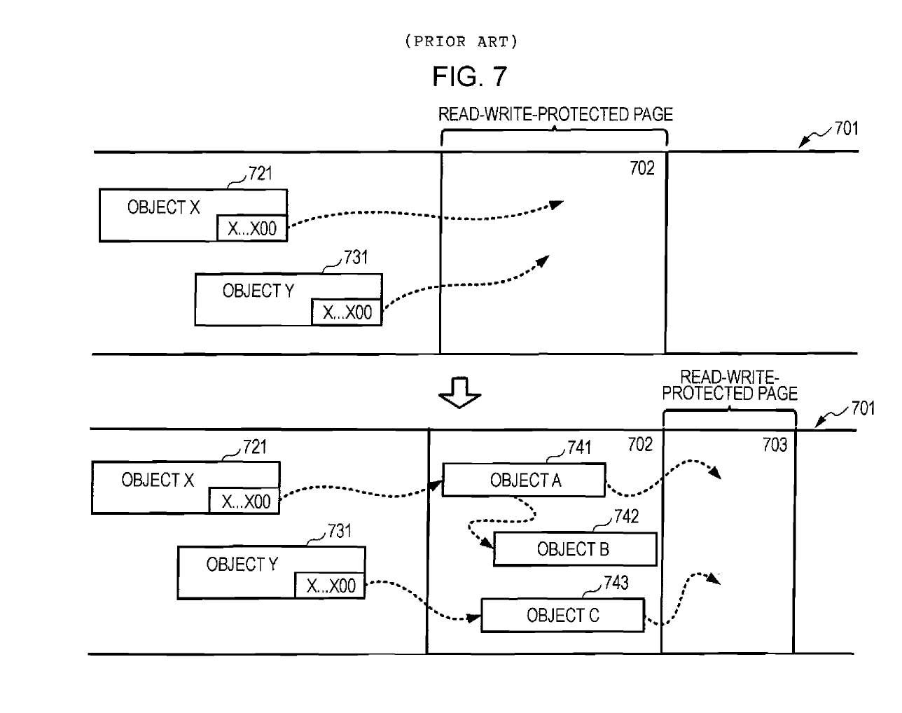

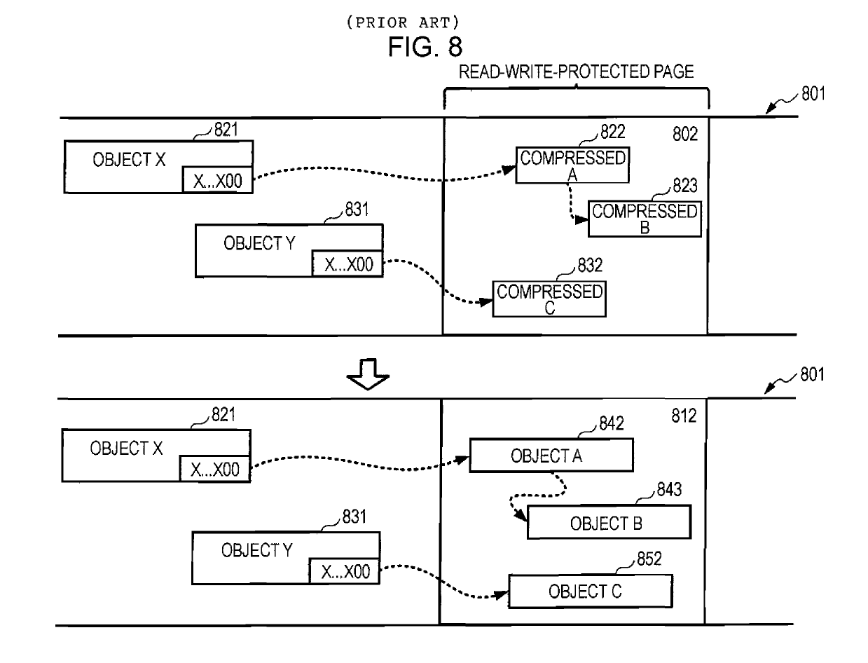

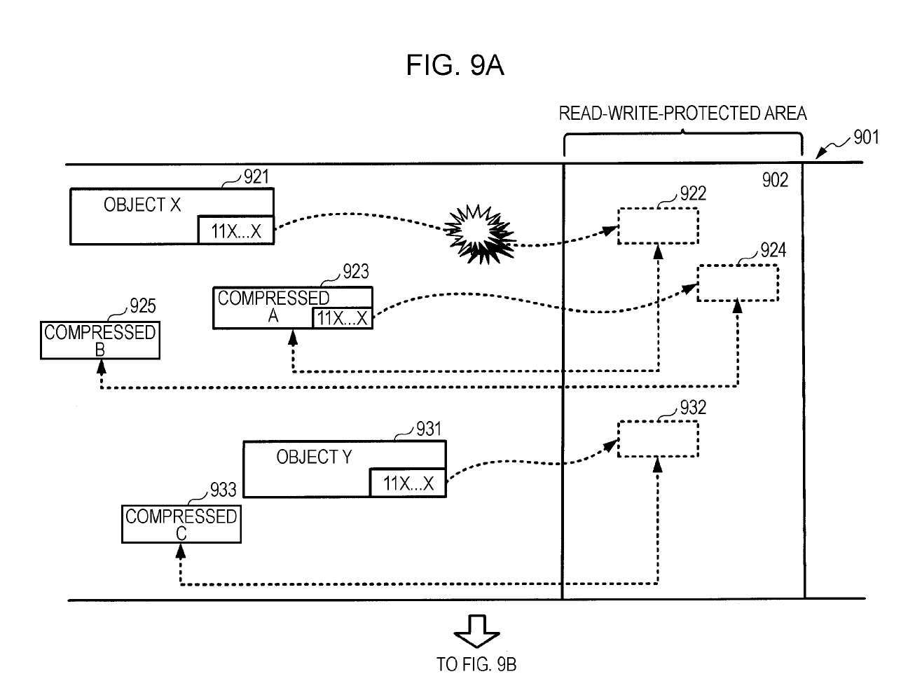

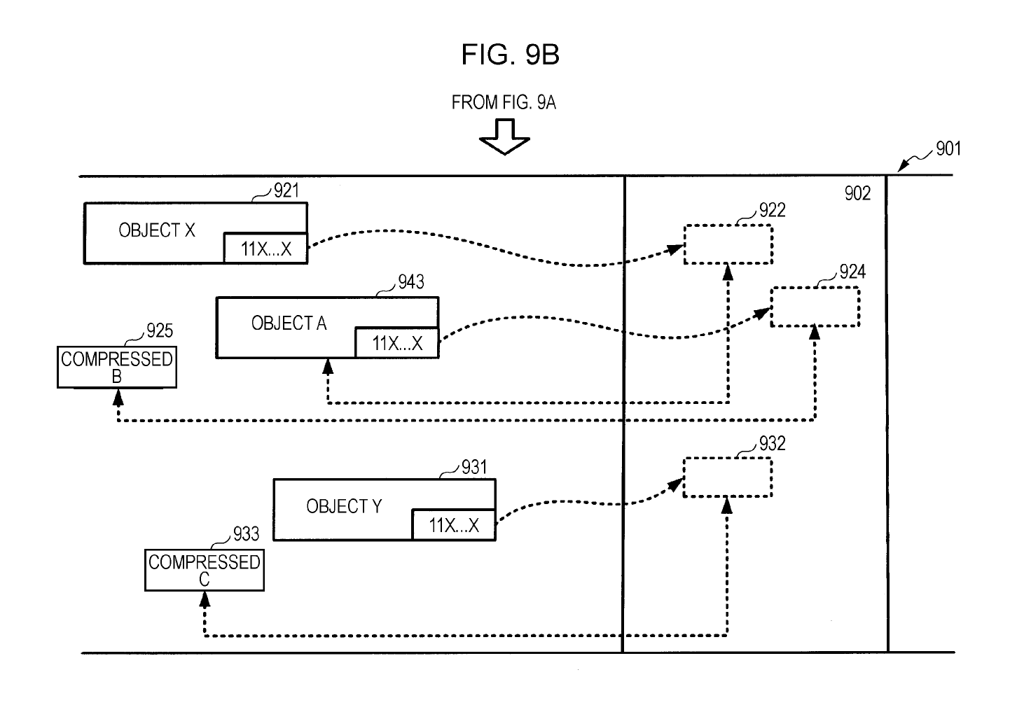

Hereinafter, a method for accessing an object in a persistent object database system in accordance with the related art (see FIG. 7 and FIG. 8 below) will be described first, in order to make content of a method for accessing an object when a pointer is converted into one pointing to a read-write-protected area in accordance with an embodiment of the present invention (see FIGS. 9A and 9B) easily understandable.

FIG. 7 illustrates a method for accessing an object in a persistent object database system in accordance with the related art.

Access to an object in the persistent object database system has characteristics as follows: (1) access to an object is monitored in units of pages; (2) this system is suitable for a case where access is performed locally in units of pages; and (3) this system is applied mainly to databases and disks, particularly, in swapping out or swapping in. The method for accessing the persistent object illustrated in FIG. 7 is described in, for example, NPL 3.

A memory of the computer (201) includes a virtual address space (701). The virtual address space (701) includes a read-write-protected page (702). It is assumed that a pointer of an object X (721) points to a head address of an object A (see 741) in the read-write-protected page (702) and a pointer of the object A (see 741) points to a head address of an object B (see 742). It is also assumed that a pointer of an object Y (731) points to a head address of an object C (see 743). It is assumed that the object A (see 741), the object B (see 742), and the object C (see 743) are in the read-write-protected page (702).

Suppose that the computer (201) accesses the object A by tracing the pointer from the object X (721) as illustrated in an upper figure of FIG. 7. When the pointed destination to the object A indicates the read-write-protected page (702), the computer (201) stops execution of all threads using a signal handler to cancel protection of the read-write-protected page (702). The virtual address space (701) after the protection is canceled is illustrated in a lower figure of FIG. 7. As illustrated by the lower figure, the computer (201) loads the object A (741) to the memory from a disk or a remote machine and restarts executing the program using the signal handler. However, in the aforementioned method, the computer (201) loads not only the object A (741) but also the object B (742) and the object C (743) that exist in the same read-write-protected page (702). Accordingly, cost of memory disadvantageously increases.

The lower figure of FIG. 7 indicates that, when an object pointed from the loaded object A (741) has not been loaded yet, the computer (201) allocates a new read-write-protected page (703) and sets the pointer of the object A (741) so that the pointer points to the read-write-protected page (703). Similarly, in the lower figure of FIG. 7, when an object pointed from the loaded object C (743) has not been loaded yet, the computer (201) allocates the new read-write-protected page (703) and sets the pointer of the object C (743) so that the pointer points to the read-write-protected page (703).

FIG. 8 illustrates a method for accessing a compressed object in the persistent object database system in accordance with the related art.

The characteristics of the persistent object database system are as described above.

The memory of the computer (201) includes a virtual address space (801). The virtual address space (801) includes a read-write-protected page (802). It is assumed that a pointer of an object X (821) points to a head address of a compressed object A (822) and a pointer of the compressed object A (822) points to a head address of a compressed object B (823). It is also assumed that a pointer of an object Y (831) points to a head address of a compressed object C (832). Additionally, it is assumed that the compressed object A (822), the compressed object B (823), and the compressed object C (832) exist in the read-write-protected page (802).

Suppose that the computer (201) traces the pointer from the object X (821) as illustrated in an upper figure of FIG. 8. When the pointed destination is in the read-write-protected page (802), the computer (201) stops execution of all threads and cancels protection of the read-write-protected page (802) using a signal handler. The virtual address space (801) after the protection is canceled is illustrated in a lower figure of FIG. 8. As illustrated in the lower figure, the computer (201) decompresses the compressed object A (822) on the memory and restarts execution of the program using the signal handler. However, in the aforementioned method, the computer (201) decompresses not only the compressed object A (822) but also the compressed object B (823) and the compressed object C (832) that are located in the same read-write-protected page (802) as the compressed object A (822). Accordingly, cost of memory disadvantageously increases.

FIGS. 9A and 9B illustrate a method for accessing an object when a pointer is converted into one that points to a read-write-protected area in accordance with an embodiment of the present invention.

Access to an object in accordance with an embodiment of the present invention has characteristics as follows: (1) access to an object is monitored not in units of pages but in units of objects; (2) the method is not suitable for a case where access is performed locally in units of pages but is suitable for a case where objects that are scattered throughout a heap are monitored for each object; and (3) the embodiment of the present invention is applied mainly to profiling of object access, compression of objects, lazy allocation of objects, and relocation of objects.

Referring to FIG. 9A, the memory of the computer (201) includes a virtual address space (901). The virtual address space (901) includes a read-write-protected area (902). It is assumed that a pointer of an object X (921) points to an address (922) in the read-write-protected area (902) and a pointer of a compressed object A (923) points to an address (924) in the read-write-protected area (902). It is also assumed that a pointer of an object Y (931) points to an address (932) in the read-write-protected area (902).

What is to be noted here is that the pointer of the object X (921) is converted from an address indicating the compressed object A (923) (i.e., a head address of the compressed object A) into a pointer pointing to the read-write-protected area (902). Additionally, the pointer of the compressed object A (923) is converted from an address indicating a compressed object B (925) (i.e., a head address of the compressed object B) into a pointer pointing to the read-write-protected area (902). The pointer of the object Y (931) is also converted from an address indicating a compressed object C (933) (i.e., a head address of the compressed object C) into a pointer pointing to the read-write-protected area (902).

Herein, to convert a pointer to a target object so that the pointer points to a read-write-protected area as described above (code manipulation) is referred to as “to barrierize”. Barrierizing is performed in allocation or GC and can be performed on all objects in an embodiment of the present invention.

Herein, a pointer converted through barrierizing is referred to as a “barrier pointer”. The term “barrier pointer” is named by the inventor. Every access via the barrier pointer causes an exception.

It should be noted that an object does not actually exist in the read-write-protected area (902) although the pointer to each object is converted to point to the read-write-protected area (902) by the conversion.

Suppose that the computer (201) traces the pointer from the object X (921). Additionally, suppose that the pointed destination indicates the address (922) in the read-write-protected area (902). Accordingly, an access request to the read-write-protected area (902) occurs. Since the pointed destination indicates the address (922) in the read-write-protected area (902), an exception occurs in response to the access request. In response to occurrence of the exception, the computer (201) reversely converts the pointer of the object X (921) into an original one using a signal handler. The computer (201) then decompresses only the compressed object A (923) to be accessed using the signal handler. The virtual address space (901) after only the compressed object A (923) is decompressed is illustrated in FIG. 9B. As illustrated in FIG. 9B, only the compressed object A (923) is decompressed and the compressed object B (925) and the compressed object C (933) are not decompressed. That is, in an embodiment of the present invention, only an object to be accessed, namely, the compressed object A (923), has to be decompressed. The computer (201) accesses a decompressed object A (943) and restarts execution of the program.

Similarly, suppose that the computer (201) traces the pointer from the object A (943) and a pointed destination indicates the address (924) in the read-write-protected area (902). Accordingly, an access request to the read-write-protected area (902) occurs. Since the pointed destination indicates the address (924) in the read-write-protected area (902), an exception occurs in response to the access request. In response to occurrence of the exception, the computer (201) reversely converts the pointer of the object A (943) into an original one using the signal handler. The computer (201) then decompresses only the compressed object B (925) to be accessed using the signal handler. That is, the compressed object C (933) is not decompressed. The computer (201) accesses the decompressed object B (925) (not illustrated) and restarts execution of the program.

Likewise, suppose that the computer (201) traces the pointer from the object Y (931) and a pointed destination indicates the address (932) in the read-write-protected area (902). Accordingly, an access request to the read-write-protected area (902) occurs. Since the pointed destination indicates the address (932) in the read-write-protected area (902), an exception occurs in response to the access request. In response to occurrence of the exception, the computer (201) reversely converts the pointer of the object Y (931) into an original one using the signal handler. The computer (201) then decompresses only the compressed object C (933) to be accessed using the signal handler. The computer (201) accesses the decompressed object C (933) (not illustrated) and restarts execution of the program.

Herein, to reversely convert the pointer having been converted by barrierizing back to an original one (code manipulation) is referred to as “to unbarrierize”.

As described above, the method according to the embodiment of the present invention can reduce cost of memory since only an object to be accessed, namely, the compressed object A (923), is decompressed and other compressed objects are not affected. That is, processing suitable for a format of each object can be performed on the object and cost of a system (e.g., an amount of memory to be used) can be advantageously reduced compared to a case where the processing is performed on all objects.

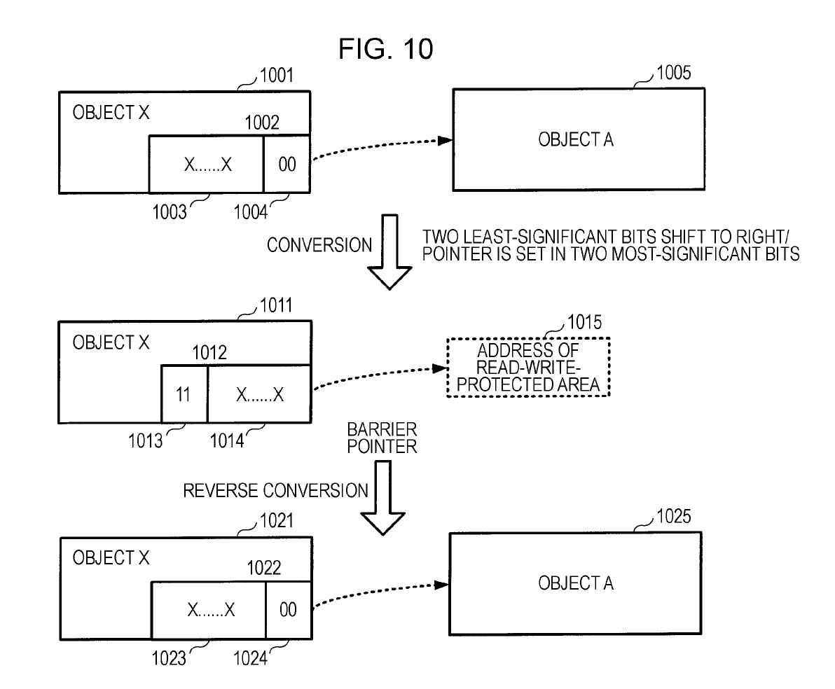

FIG. 10 illustrates an example of converting a pointer to an object into one that points to a read-write-protected area in accordance with an embodiment of the present invention.

A pointer (1002) included in an object X (1001) is a pointer to an object A (1005). The pointer (1002) is an unconverted pointer. Two or three least-significant bits (1004) of the pointer are generally zero. Other bits represent an address (1003) of an object to be accessed. The address (1003) corresponds to a head address of the object A (1005), for example.

In accordance with an embodiment of the present invention, a fact that the two or three least-significant bits (1004) of the pointer (1002) are zero is utilized.

In accordance with an embodiment of the present invention, the pointer (1002) is converted into one pointing to the read-write-protected area by performing the following pointer bit manipulation. In one conversion example, for example, a value of the pointer (1002) is shifted to the right by n bits (where n is an integer and is, for example, 2 or 3) and a pointer value indicating the read-write-protected area is set in the empty most-significant bits.

A pointer (1012) is generated by the above conversion. The number of most-significant n bits (1013) is the same as the number of bits by which the pointer is shifted to the right. Other bits (1014) are the same as the aforementioned bits (1003). The first part (1013) of the pointer (1012) indicates an address (1015) of the read-write-protected area.

The read-write-protected area is, for example, a memory area generated by a specific language (e.g., a read-write-protected area outside a Java* heap) and is, for example, an OS memory area. The read-write-protected area may also be an address causing an exception, for example. For example, when 32-bit Linux* is installed in a computer, a read-write-protected area thereof is at an address of 0xC0000000 or larger. The read-write-protected area is inaccessible to users. Additionally, addresses of the read-write-protected area compliant with a programming language of the computer may be used.

In accordance with an embodiment of the present invention, a pointer does not have to be assigned to a real memory by using the read-write-protected area in barrierizing and the virtual memory area has to be only reserved and protected. Additionally, in accordance with an embodiment of the present invention, even the virtual memory area of a user space does not have to be reserved.

In accordance with an embodiment of the present invention, the pointer (1012) is reversely converted by performing the following pointer bit manipulation. As a result of the reverse conversion, a pointer (1022) of an object X (1021) comes to point to a head address of an object A (1025). That is, the converted pointer is reversely converted into an original one. The reverse conversion is performed by shifting the value of the pointer (1012) to the left by n bits (where n is an integer, for example, n is 2 or 3) and zero is set at empty least-significant bits resulting from left-shifting (1024). Through this reverse conversion, the pointer (1022) (which is the same as the pointer 1002) is generated from the pointer (1012) and access to the target object A (1025) can be detected.

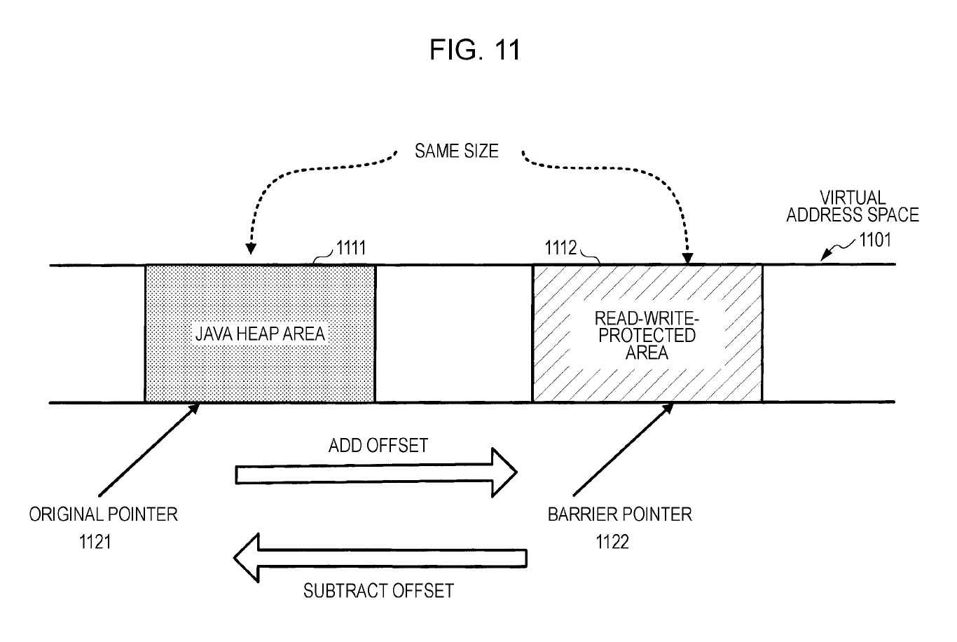

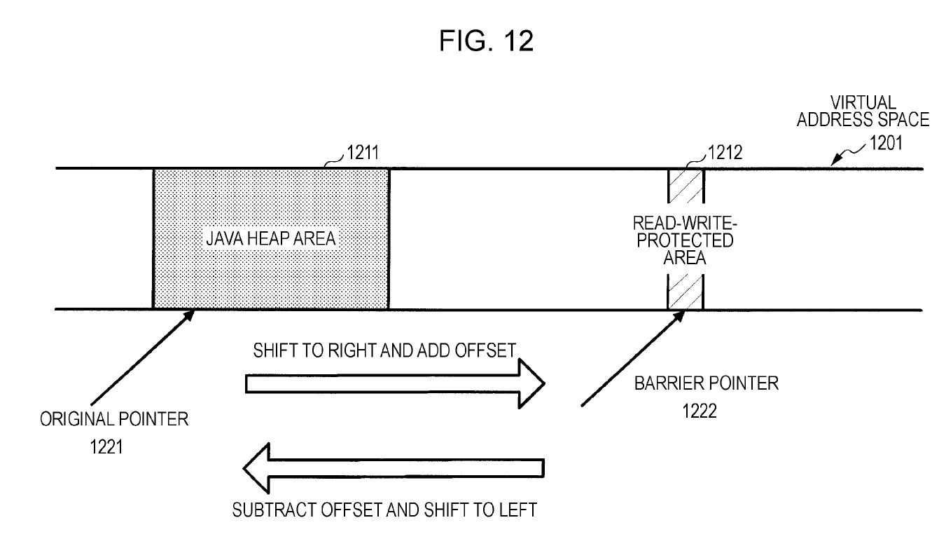

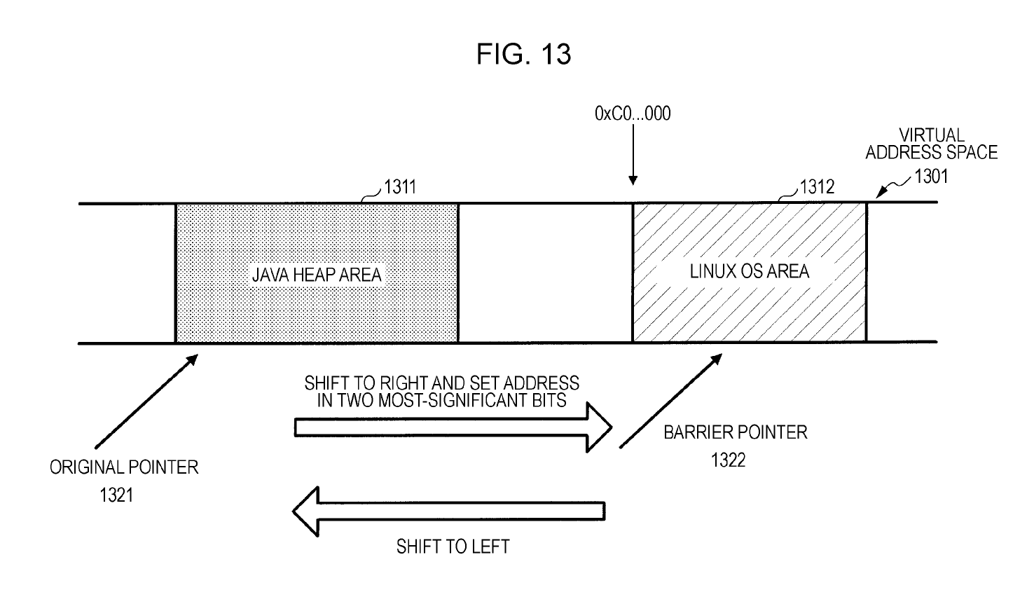

FIG. 11 to FIG. 13 illustrate various examples of barrier pointers in accordance with an embodiment of the present invention. Each of FIG. 11 to FIG. 13 illustrates a memory layout. A barrier pointer in FIG. 11 is a basic one, whereas barrier pointers in FIG. 12 and FIG. 13 are extended ones. In this embodiment of the present invention, those skilled in the art may use the barrier pointers in FIG. 11 to FIG. 13 and barrier pointers in other forms.

FIG. 11 illustrates an example of a barrier pointer when a read-write-protected area and a heap area are the same size in accordance with an embodiment of the present invention.

A virtual address space (1101) includes a Java* heap area (1111) and a read-write-protected area (1112). An original pointer is represented by an arrow (1121), whereas a barrier pointer is represented by an arrow (1122).

In the example in FIG. 11, the read-write-protected area (1112) is reserved so that the read-write-protected area (1112) is in the same address size as the Java* heap area (1111). The use of the same address size simplifies implementation. In barrierizing, a certain offset between the Java* heap area (1111) and the read-write-protected area (1112) is added to a pointer. In contrast, in unbarrierizing, the certain offset is subtracted. The offset is constant throughout initialization of a Java* VM and execution of programs. Most operating systems have a system call for reserving a read-write-protected virtual address area. It should be noted here that the read-write-protected area (1112) does not require assignment of a real memory. Recent operating systems do not assign a real memory to a virtual page until content in the real memory is accessed by a program for the first time. The read-write-protected area (1112) is used only for causing an exception. Accordingly, content of the read-write-protected area (1112) is not accessed from outside and the real memory is not required. If the Java* heap area (1111) is dynamically expanded in the case illustrated in FIG. 11, the read-write-protected area (1112) also has to be expanded similarly. However, success of this expansion is not guaranteed generally. Thus, the size of the read-write-protected area (1112) is set to match the maximum size of the Java* heap area (1111) when execution of a program is started. The size of the read-write-protected area (1112) may be set so that the size is not smaller than that of the Java* heap area (1111).

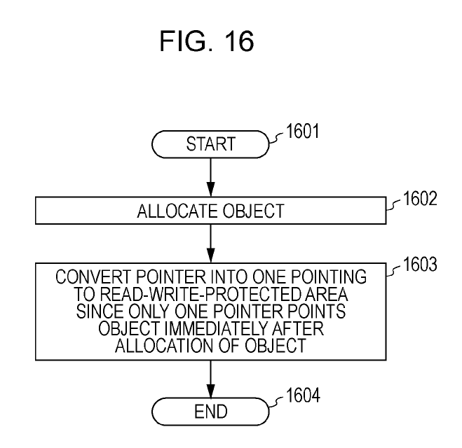

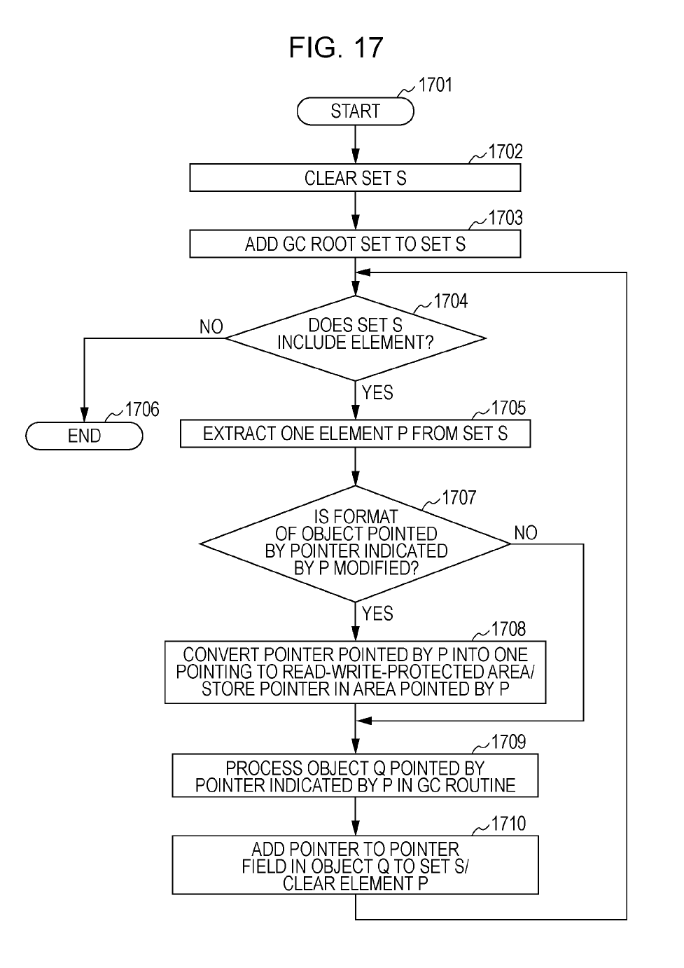

Barrierizing may be performed in object allocation (see FIG. 16 below) or GC (see FIG. 17 below). Barrierizing at the time of object allocation is useful to profile or optimize objects allocated at a given allocation portion. In order to allow a barrier pointer to accurately operate, it is important to barrierize all pointers pointing to a target object. This can be done by barrierizing a register in a generated JIT code or a modified interpreter since only one pointer in the register points to an allocated object immediately after the allocation. In contrast, barrierizing in GC is suitable for profiling or optimizing objects living for a long time.

In an embodiment of the present invention, the barrierizing and unbarrierizing method illustrated in FIG. 11, among those illustrated in FIG. 11 to FIG. 13, is the most basic method.

FIG. 12 illustrates an example of a barrier pointer when a read-write-protected area is smaller in size than a heap area in accordance with an embodiment of the present invention.

A virtual address space (1201) includes a Java* heap area (1211) and a read-write-protected area (1212). An original pointer is represented by an arrow (1221), whereas a barrier pointer is represented by an arrow (1222). An object used in FIG. 12 is aligned in units of eight bytes, for example. In general CPU design, for example, an attempt to read 8-byte data from a non-8-byte-aligned address causes overhead. If a head of the object is aligned in units of 8 bytes, a field in the object is also aligned in units of 8 bytes. Accordingly, the access does not cause extra overhead.

In the example in FIG. 11, the size of the read-write-protected area (1112) is set to match or to be larger than the maximum size of the Java* heap area (1111). However, the virtual address space (1101) is a limited resource. An extra area in the virtual address space also increases translation lookaside buffer (TLB) misses. Accordingly, it is desirable to make the read-write-protected area as small as possible.

In the example in FIG. 12, the read-write-protected area (1212) is reserved so that the read-write-protected area (1212) is smaller than the Java* heap area (1211) in size. For example, the read-write-protected area (1212) may be one-eighth of the Java* heap area (1211) in size. In barrierizing, a value of a pointer is shifted to the right by n bits and a certain offset is added to the right-shifted value. On the other hand, in unbarrierizing, the certain offset is subtracted and the value is shifted to the left by the n bits. As in the example of FIG. 11, barrierizing is performed in object allocation or GC.

As illustrated in FIG. 12, a Java* VM may utilize a fact that all Java* objects are aligned at 8-byte boundaries for the smaller read-write-protected area (1212). Since three least-significant bits of a value of each object pointer are zero, the value can be shifted to the right by three bits without losing any information. Accordingly, the size of the read-write-protected area (1212) may be one-eighth of the Java* heap area (1211) in size as described above. In barrierizing in FIG. 12, the barrier pointer can be represented by Expression 1.

Barrier_pointer=(Original_pointer−HEAP_BASE)>>3+PROTECTED_BASE [Expression 1]

Expression 1 can be represented in a simplified form as denoted by Expression 2.

Barrier_pointer=Original_pointer>>3+CONSTANT; CONSTANT=PROTECTED_BASE−HEAP_BASE>>3 [Expression 2]

A problem regarding the barrier pointer illustrated in FIG. 12 is that an address outside the read-write-protected area (1212) may be accessed via the barrier pointer. Accordingly, this condition has to be checked when a pointer to an object is barrierized. This check can be represented by Expression 3.

Barrier_pointer+Object_size<=PROTECTED_TOP, [Expression 3]

where PROTECTED_TOP denotes a top address of the read-write-protected area.

FIG. 13 illustrates an example of a barrier pointer when an OS protection area serves as a read-write-protected area in accordance with an embodiment of the present invention.

FIG. 13 illustrates a method for reducing the size of the read-write-protected area with a method different from the one in FIG. 12.

In the example of FIG. 13, a virtual address space (1301) includes a Java* heap area (1311) and a Linux* OS area (1312). Since the Linux* OS area (1312) is an address range used by the OS, it is read-write protected. An original pointer is represented by an arrow (1321), whereas a barrier pointer is presented by an arrow (1322).

In the example of FIG. 13, the Linux* OS area (1312) occupies a quarter of the virtual address space (1301) in accordance with a specification of a Linux* OS program and starts from 0xC0 . . . 000. Users cannot access this Linux* OS area (1312). In barrierizing, a value of a pointer is shifted to the right by n bits and an address indicating a head of the Linux* OS area (1312) is set in the two empty bits (e.g., 11 in the example case of FIG. 13). On the other hand, in unbarrierizing, the value of the pointer is shifted to the left by the n bits. In a Java* VM, the read-write-protected area does not have to be reserved in a user space. For example, regarding 32-bit Windows*, the OS typically reserves a half or a quarter of a virtual address space. For example, regarding 32-bit AIX*, the OS typically occupies 1/16 of a 4 GB virtual address space. This indicates that the Java* VM may reserve 256 MB in another location in order to reserve the read-write-protected area. Barrierizing is performed in object allocation or GC as in the example of FIG. 11.

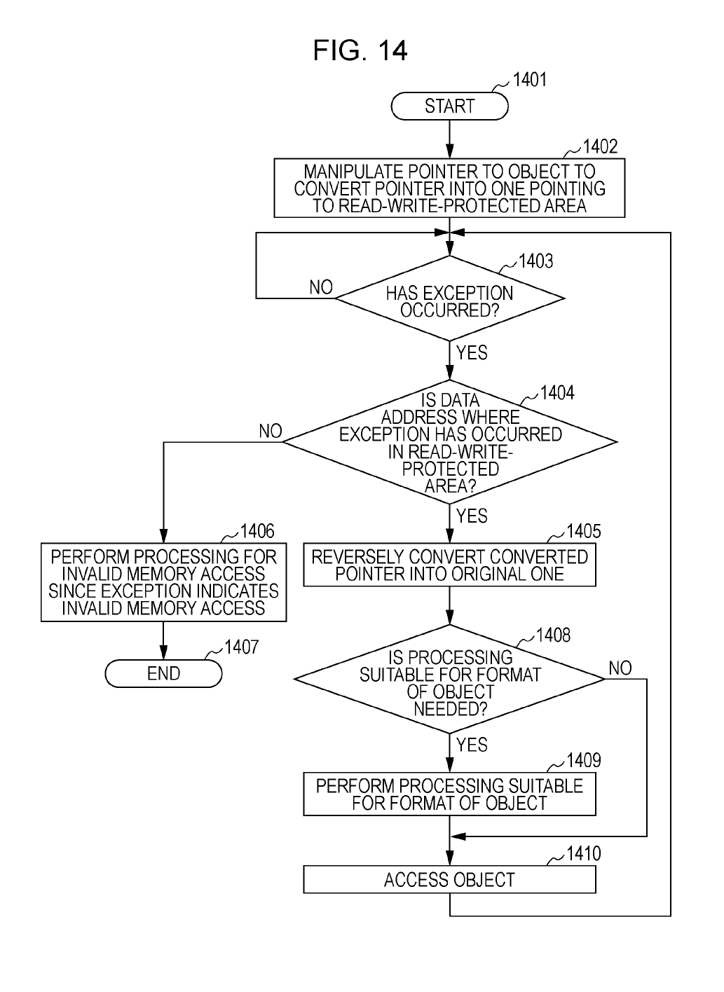

FIG. 14 illustrates a flowchart of a method for detecting access to an object in accordance with an embodiment of the present invention.

In step 1401, the computer (201) starts an algorithm for detecting access to an object.

In step 1402, the conversion unit (211) performs code manipulation on a pointer to the object (a target object) to convert the pointer into one pointing to a read-write-protected area. A manner of converting the pointer is as described in the explanation of the conversion unit (211). Here, it has to be guaranteed that a pointer to within the object points to the read-write-protected area by the conversion when a part other than the head of the object is accessed. In order to guarantee this, it has to be determined, when the original pointer is barrierized, that a sum of a value of the barrier pointer and the size of the object does not exceed the read-write-protected area. Even if the sum exceeds the read-write-protected area, the only inconvenience caused here is to give up barrierizing. Accordingly, a format is not converted into a non-ordinary one regarding this object.

In step 1403, when an exception occurs in access to the read-write-protected area, the computer (201) detects the memory access exception and starts a signal handler. When the exception has occurred, the process proceeds to step 1404. In contrast, when the exception has not occurred, the computer (201) stands-by until the exception occurs. The computer (201) performs the following processing in steps 1404 to 1410 using the started signal handler.

In step 1404, the computer (201) determines whether a data address where the exception has occurred is in the read-write-protected area using the signal handler. The exception having occurred may be, for example, a segmentation fault. When the data address where the exception has occurred is in the read-write-protected area, the process proceeds to step 1405. On the other hand, when the data address where the exception has occurred is not in the read-write-protected area, the process proceeds to step 1406.

In step 1405, the reverse conversion unit (212) reversely converts the converted pointer into the original one using the signal handler when the data address where the exception has occurred is in the read-write-protected area. Although a manner of reversely converting the pointer according to the embodiment of the present invention is as described in the explanation of the reverse conversion unit (212), an operation of the reverse conversion unit (212) will be described below in detail.

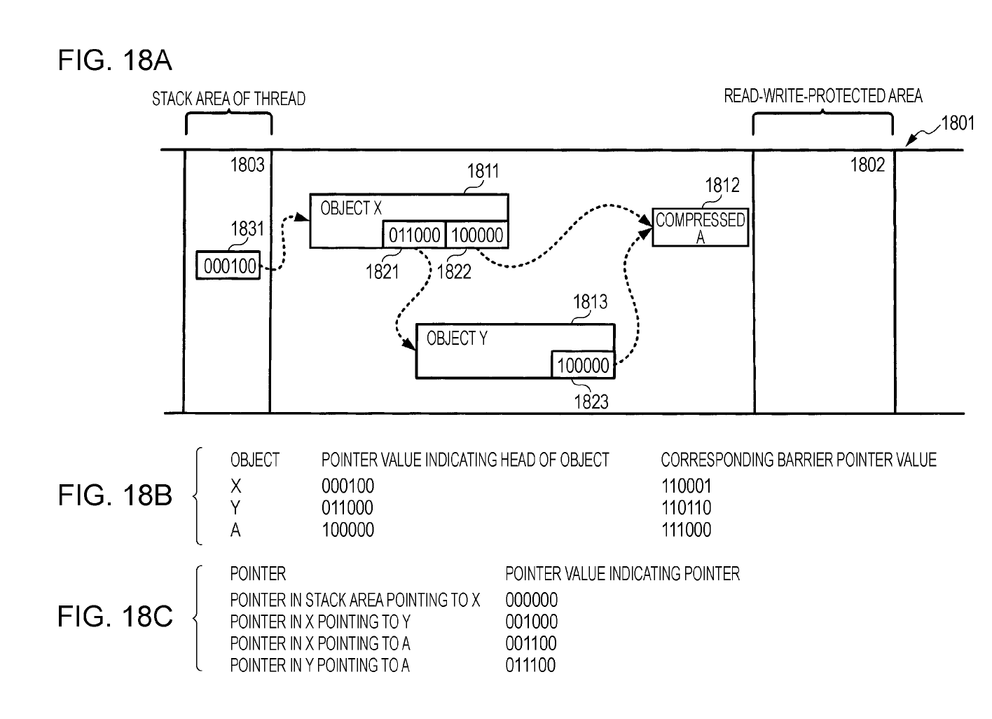

The signal handler has to acquire a pointer to a head of an object to be originally accessed because the computer (201) has to read out a header and so forth of the original object from a pointed destination of the pointer to the head of the original object and determine whether to decompress a compressed object when the original object is compressed. To acquire the pointer to the head of the original object, the signal handler performs the following processing. Since the computer (201) can generally find an address of an instruction where the exception has occurred using the signal handler, the computer (201) reads out the instruction at the address and acquires, for example, an instruction in a format represented by Expression 4 (see an explanation in Description of Embodiments corresponding to FIG. 18 below).

load, load-destination register, [register having pointer value, offset] [Expression 4]

Furthermore, since the computer (201) can read a value held in the register when the exception has occurred using the signal handler, the computer (201) can read the pointer value contained in the “register having pointer value” in the format. Accordingly, the JIT compiler or interpreter is modified so that the instruction for accessing the object is in a format represented by Expression 5.

load, load-destination register, [register having pointer value to head of object, offset] [Expression 5]

However, since the object is accessed in the above format in most codes output by the present JIT compiler or the interpreter, the modification is rarely needed. In this way, the computer (201) reads out the instruction represented by Expression 2 and further reads out the “pointer value to head of object” using the signal handler. Since the “pointer value to head of object” is actually a barrier pointer, the computer (201) performs unbarrierizing on the “pointer value to head of object” using the signal handler. As a result, the computer (201) can get the pointer value to the head of the original object.

For example, when a memory reference is denoted in a format [base_reg_object_head, reg_offset/imm_offset], the computer (201) reads base_reg_object_head and performs unberrierizing to perform reverse conversion (see an explanation in Description of Embodiments corresponding to FIG. 18). Additionally, in the example case mentioned in step 1402, the reverse conversion is performed by shifting the converted pointer to the left by the same n bits as the n bits by which the pointer is shifted to the right in step 1402. Alternatively, the reverse conversion is performed by, for example, referring to an instruction that has caused the exception, acquiring the converted pointer to the head of the object from the instruction that has caused the exception, reversely converting the acquired pointer to acquire the pointer to the head of the original object.

In step 1408, the processing unit (213) determines whether processing suitable for the object is needed with reference to header information of the object, for example. A mark for identifying compression or lazy allocation, for example, is written in the header of the object. For example, when “0” is written in a specific field of the header, “0” indicates an ordinary format. When “1” is written in the same field, “1” indicates a compressed format. When “2” is written in the same field, “2” indicates a lazy allocation format. When the processing suitable for the object is needed, the process proceeds to step 1409. On the other hand, when the processing suitable for the object is not needed, the process proceeds to step 1410.

In step 1409, the processing unit (213) performs processing suitable for the format of the object with reference to the header information of the object pointed to by the reversely converted original pointer using the signal handler. Kinds of processing suitable for the format of the object include, for example, recording a log of object access, returning the format of the object back to the original one, and accessing a field of the object in a new format. By recording the object access log, the method for detecting access to an object in accordance with the embodiment of the present invention can be used in optimization of a program. To return the format of the object back to the original indicates, for example, to decompress a compressed object when the object to be accessed is compressed or to lazily allocate a character array to be accessed.

In step 1410, the execution unit (214) accesses the object pointed to by the reversely converted original pointer using the signal handler. The process then returns to step 1403.

In step 1406, the computer (201) determines that the exception is an invalid access when the data address where the exception has occurred is not in the read-write-protected area and performs processing for the invalid access using the signal handler. The processing may be, for example, acquisition of a memory dump.

In step 1407, the computer (201) terminates the algorithm for detecting access to the object.

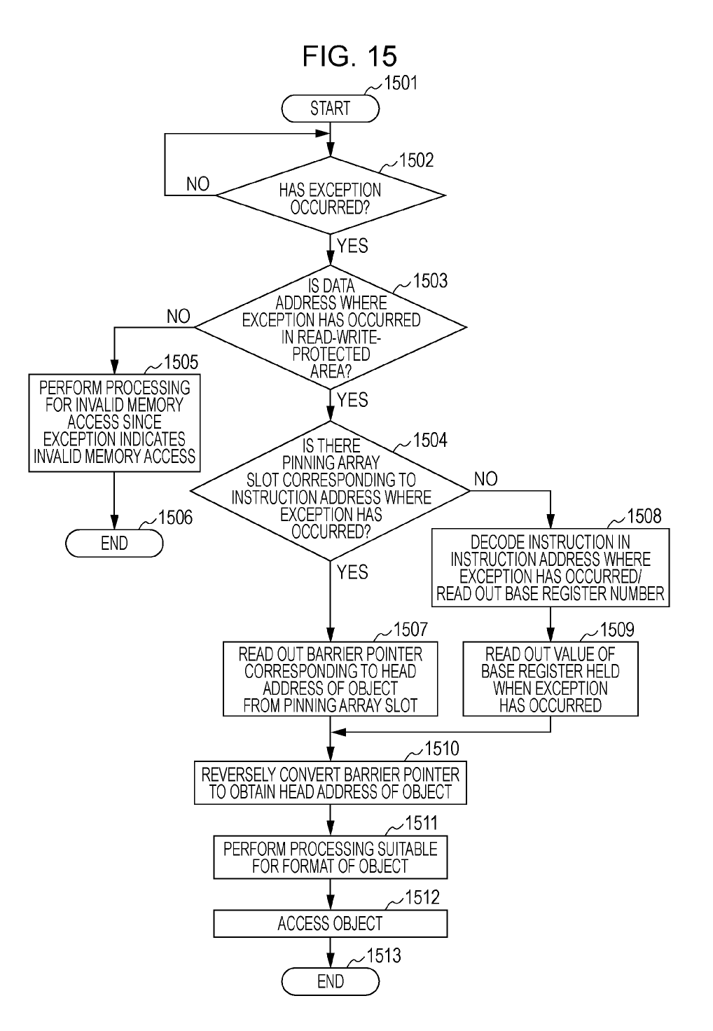

FIG. 15 illustrates a flowchart of an algorithm for processing a memory access exception using a pinning array slot in accordance with an embodiment of the present invention.

It has been described in the algorithm of FIG. 14 that unbarrierizing is performed using an expression [register having pointer value to head of object, offset] (see Expression 5) in step 1405 executed by the reverse conversion unit (212) and the pointer value to the head of the original object is acquired. However, there may be object access that does not fit into such a format. In particular, this may be seen in access to array objects. Accordingly, this process flow may be used when an array object is accessed. The process flow illustrated in FIG. 15 differs from the one in FIG. 14 in that the process flow in FIG. 15 has steps 1504 and 1507. When the process proceeds to steps 1508 and 1509, processing corresponding to that of FIG. 14 (i.e., without the pinning array slot) is performed.

The access to the array object may be in an instruction sequence represented by Expressions 6 to 8.

register X=pointer value to head of array object [Expression 6]

register X=register X+index [Expression 7]

load, load-destination register, [register X, offset] [Expression 8]

When the pointer value in Expression 6 is a barrier pointer, it is generally difficult to acquire the pointer value to the head of the original array object from the value of the register X in Expression 8. This is because merely performing unbarrierizing results in an incorrect pointer value. Since such a value of the register X does not indicate the head of the object but indicates a location inside the object, the value is referred to as an internal pointer. Accordingly, regarding access to such array objects, the JIT compiler or the interpreter is modified so that the access is done as represented by Expressions 9 to 12.

register X=pointer value to head of array object [Expression 9]

pinning_array_slot=register X [Expression 10]

register X=register X+index [Expression 11]

load, load-destination register, [register X, offset] [Expression 12]

In Expression 10, the pointer value to the head of the array object is stored in the pinning array slot. The pinning array slot is an area in which the pointer value to the head of the object is stored. The pinning array slot is actually in another register or stack. A correspondence table between an instruction address of Expression 12 and a register or slot number of the register or the slot of the corresponding pinning array slot is also created. The signal handler looks up the correspondence table using, as a key, the address of the instruction where the exception has occurred. If the corresponding pinning array slot exists, the signal handler reads out the pointer value to the head of the array object from the corresponding pinning array slot. Since the read out pointer value is a barrier pointer, the pointer value to the head of the original array object can be acquired by performing unbarrierizing. This pinning array slot is already supported by, for example, a Java* VM as, for example, an internal pointer aware GC, so that the GC can move the object. The internal pointer aware GC indicates a GC that can handle a pointer pointing to inside an object. Accordingly, there is no need to actually modify the JIT compiler or the interpreter. However, the correspondence table has to be newly prepared in the embodiment of the present invention. Additionally, since array access using the internal pointers is actually rare in the program and the size of the correspondence table does not become too large, the correspondence table does not consume too much memory.

A flowchart for processing, using the pinning array slot, an access exception to an array object that uses the internal pointer will be described below.

In step 1501, the computer (201) starts the processing of the memory access exception using a signal handler. More specifically, an exception occurs in access to a read-write-protected area after the process is started and the computer (201) invokes and executes the signal handler.

In step 1502, when the exception occurs in access to the read-write-protected area, the computer (201) detects the exception and starts the signal handler. When the exception has occurred, the process proceeds to step 1503. On the other hand, when the exception has not occurred, the computer (201) stands by until the exception occurs. The computer (201) performs the following processing in steps 1503 to 1513 using the started signal handler.

In step 1503, the computer (201) determines, using the signal handler, whether a data address where the exception has occurred is in the read-write-protected area. The occurred exception may be, for example, a segmentation violation (also referred to as a segmentation fault). The segmentation violation is a specific error condition that occurs during execution of software and occurs when access to a location in the memory where access is not permitted is attempted or when access to a location in the memory is attempted in an unpermitted method (e.g., writing information in a read-only location or overwriting an operating system part is attempted). When the data address where the exception has occurred is in the read-write-protected area, the process proceeds to step 1504. On the other hand, when the data address where the exception has occurred is not in the read-write-protected area, the process proceeds to step 1505.

In step 1504, the computer (201) determines, using the signal handler, whether there is a pinning array slot corresponding to the instruction address where the exception has occurred. Each access is associated with a stack slot including a pointer to head of an array object. This associated slot is referred to as a pinning array slot as described above. The pinning array slot is associated with each instruction. When the pinning array slot exists, the process proceeds to step 1507.

In step 1507, the computer (201) reads out a barrier pointer corresponding to the head address of the original object from the pinning array slot using the signal handler.

In step 1510, the computer (201) reversely converts the read out barrier pointer using the signal handler to acquire the head address of the original object. The reverse conversion is as described above.

In step 1511, the computer (201) performs processing suitable for a format of the object with reference to header information of the object pointed to by the reversely converted original pointer using the signal handler. Examples of the processing suitable for the format of the object include, for example, recording a log of object access, returning a format of the object back to the original one, and accessing a field of the object in a new format. Returning the format of the object back to the original one indicates, for example, decompressing a compressed object when the object is compressed or lazily allocating a character array.

In step 1512, the computer (201) accesses, using the signal handler, the object pointed to by the reversely converted original pointer. The process then proceeds to step 1513.

In step 1513, the computer (201) terminates, using the signal handler, the method for processing the memory access exception.

When the data address where the exception has occurred is not in the read-write-protected area, the computer (201) determines, using the signal handler, that the exception is an invalid access and performs processing for the invalid access, such as acquisition of a memory dump.

In step 1506, the computer (201) terminates, using the signal handler, the method for processing the memory access exception.

In step 1508, the computer (201) decodes, using the signal handler, an instruction in the instruction address where the exception has occurred and reads out a base register number to the memory. The computer (201) can read out all register values held when the exception has occurred using the signal handler.

In step 1509, the computer (201) reads out, to the memory, a register value corresponding to the base register number read out in step 1508 using the signal handler. The read out register value is a barrier pointer corresponding to the head address of the original object. The process proceeds to step 1510. The read out register value (which is the barrier pointer) is reversely converted and the head address of the original object is acquired as described above.

FIG. 16 and FIG. 17 illustrate examples of various barrierizing processes in accordance with an embodiment of the present invention. Barrierizing is executed in step 1402 of FIG. 14.

FIG. 16 illustrates a flowchart of a process flow for performing barrierizing in object allocation in accordance with an embodiment of the present invention.

Steps 1601 to 1604 of FIG. 16 are one embodiment of the processing performed in step 1402 of FIG. 14.

In step 1601, the computer (201) starts barrierizing.

In step 1602, the computer (201) allocates an object in a heap memory. There is only one pointer that points to the allocated object immediately after the allocation of the object.

In step 1603, the computer (201) converts the pointer into one that points to a read-write-protected area immediately after the allocation of the object.

In step 1604, the computer (201) terminates the algorithm in response to completion of the conversion.

FIG. 17 illustrates a flowchart of an algorithm for performing barrierizing in GC in accordance with an embodiment of the present invention.

Steps 1701 to 1710 of FIG. 17 are an alternative embodiment of the processing performed in step 1402 of FIG. 14.

In step 1701, the computer (201) starts barrierizing.

In step 1702, the computer (201) clears a set S to store a pointer to another pointer.

In step 1703, the computer (201) adds a GC root set, such as a register or a stack, to the set S.

In step 1704, the computer (201) examines whether the set S includes an element. When the set S includes an element, the process proceeds to step 1705. On the other hand, when the set S includes no elements, the process proceeds to step 1706.

In step 1705, the computer (201) extracts one element from the set S when the set S includes the element. This extracted element is referred to as an element P, which is a pointer to another pointer.

In step 1706, the computer (201) terminates the process when the set S includes no elements.

In step 1707, the computer (201) examines whether a format of an object pointed to by a pointer indicated by the element P is a modified object format. When the format is the modified format, the process proceeds to step 1708. On the other hand, when the format is not the modified format, the process proceeds to step 1709.

In step 1708, the computer (201) converts the pointer pointed to by the element P into one that points to the read-write-protected area when the format of the object pointed to by the pointer indicated by the element P is the modified object format and stores the converted pointer in a memory pointed to by the element P. Step 1708 corresponds to a step of barrierizing in GC.

In step 1709, the computer (201) processes an object Q pointed to by the pointer indicated by the element P in a GC routine. The GC routine typically attaches a mark to the object Q while considering that the object Q is alive.

In step 1710, the computer (201) adds pointers to pointer fields (e.g., 322 in FIG. 3) in the object Q to the set S.

FIG. 18 to FIG. 25 illustrates examples of a virtual address space in each step of FIG. 17 in accordance with an embodiment of the present invention.

FIG. 18A illustrates a virtual address space in step 1701 of FIG. 17 (before GC is started) in accordance with an embodiment of the present invention.

A memory of the computer (201) includes a virtual address space (1801). The virtual address space (1801) includes a read-write-protected area (1802) and a stack area (1803) of a thread. No real memory is allocated in the read-write-protected area (1802). The stack area (1803) of the thread is part of the GC root set.

A pointer (1821) of an object X (1811) points to a head address of an object Y (1813). A pointer (1822) of the object X (1811) points to a head address of a compressed object A (1812). A pointer (1823) of the object Y (1813) points to the head address of the compressed object A (1812).

Additionally, a pointer (1831) in the stack area (1803) of the thread points to a head address of the object X (1811).

The object A (1812) is in a compressed format. Accordingly, the pointers (1822 and 1823) to the object A have to be converted into barrier pointers.

FIG. 18B illustrates the objects X, Y, and A, pointer values indicating the head addresses of the respective objects X, Y, and A, and barrier pointer values for the corresponding objects X, Y, and A. Meanwhile, a pointer for the ordinary object format has a pointer value whose two most-significant bits are not 11. A barrier pointer has a value obtained by shifting the pointer value for the ordinary object format to the right by two bits and setting “11” in the two most-significant empty bits.

FIG. 18C illustrates four pointers illustrated in FIG. 18 to FIG. 25 and pointer values indicating the pointers (it should be noted that the pointer values are not values held by the corresponding pointers). The pointer value indicating the pointer is a given value.

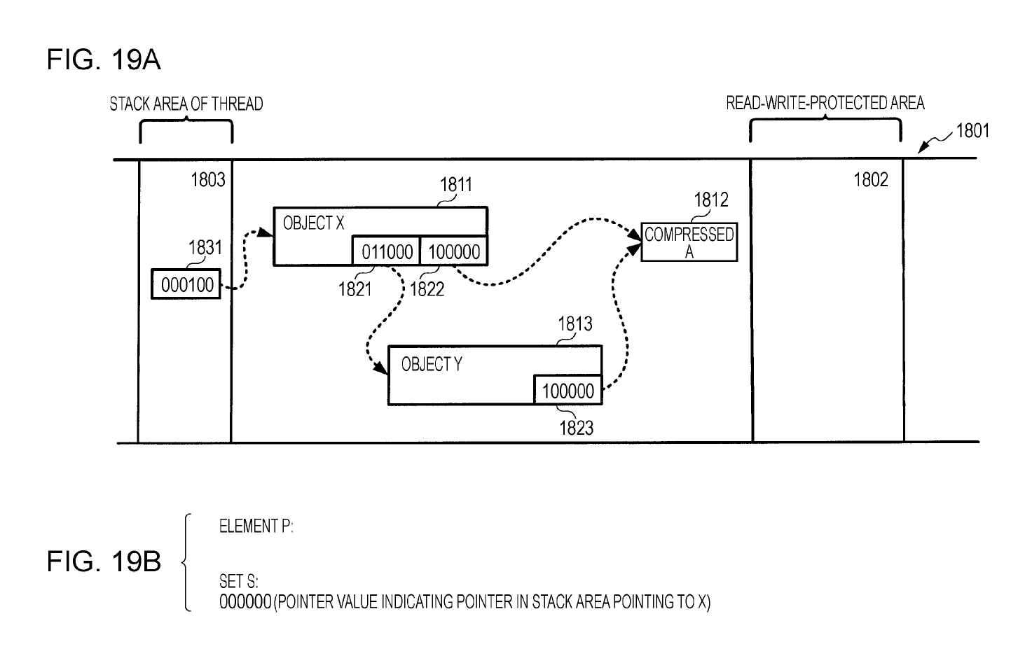

FIG. 19A illustrates a virtual address space in step 1703 of FIG. 17 in accordance with an embodiment of the present invention.

Since the GC root set is added to the set S in step 1703, the computer (201) adds a pointer value (000000) indicating the pointer, in the stack area, pointing to the object X to the set S (FIG. 19B).

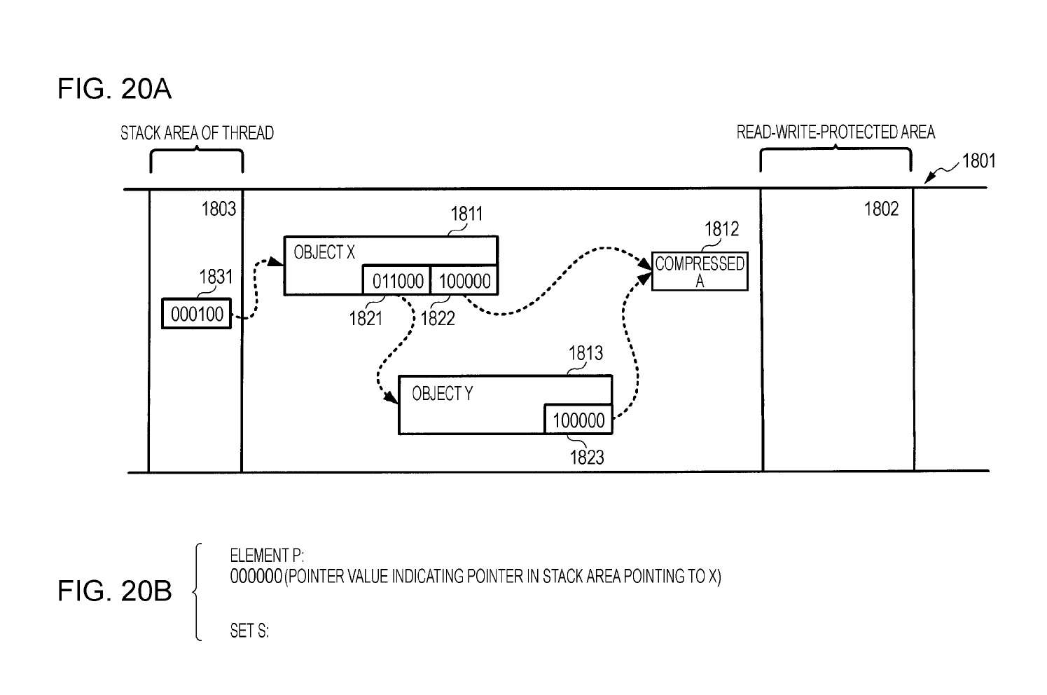

FIG. 20A illustrates a virtual address space processed in steps 1704 and 1705 of FIG. 17 in accordance with an embodiment of the present invention.

Since the computer (201) extracts the element P from the set S in step 1705, the computer (201) extracts the pointer value (000000) indicating the pointer, in the stack area, pointing to the object X from the set S (FIG. 20B).

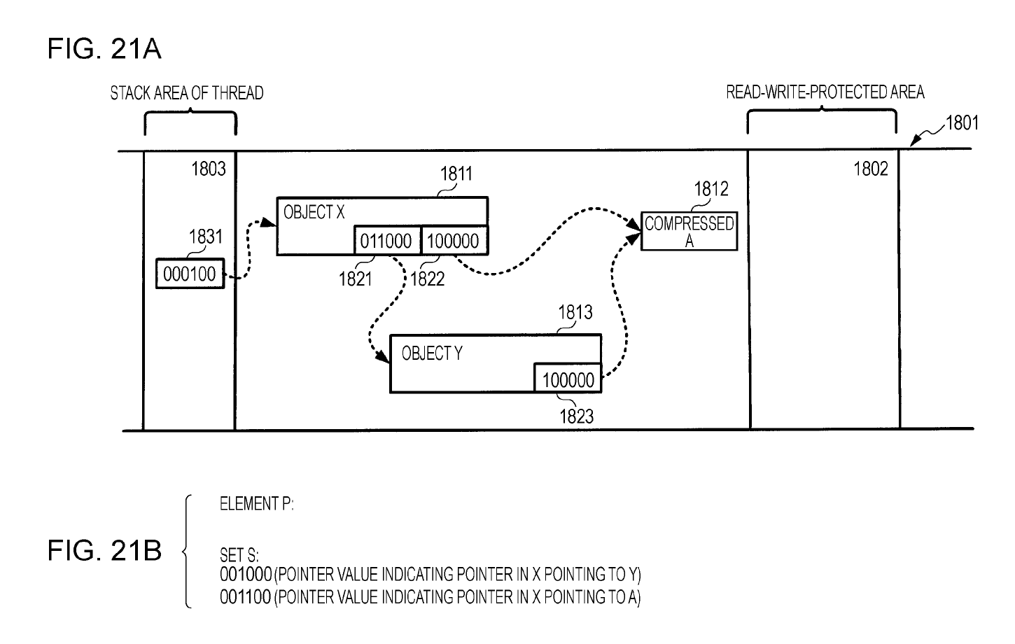

FIG. 21A illustrates a virtual address space processed in steps 1707, 1709, and 1710 of FIG. 17 in accordance with an embodiment of the present invention.

In step 1710, the computer (201) adds the pointers to the pointer fields in the object X to the set S (FIG. 21B). More specifically, the computer (201) adds a pointer value (001000) indicating the pointer, in the object X, pointing to the object Y and a pointer value (001100) indicating the pointer, in the object X, pointing to the object A to the set S. The computer (201) then clears the element P. Meanwhile, the object X in FIG. 21A corresponds to the object Q in step 1710 of FIG. 17.

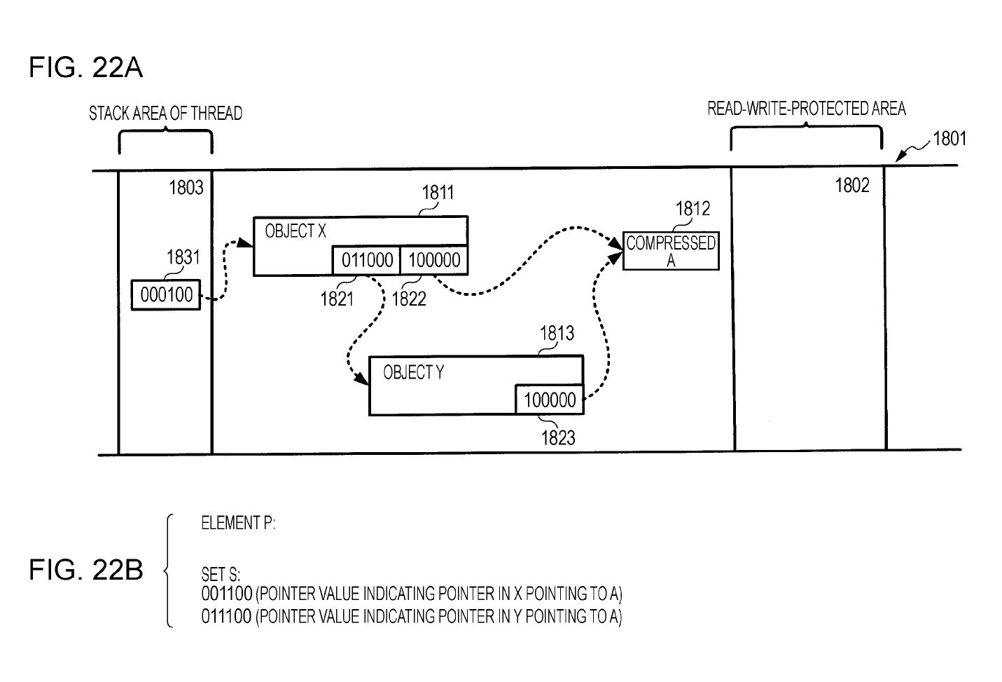

FIG. 22A illustrates a virtual address space processed in steps 1704, 1705, 1707, 1709, and 1710 of FIG. 17 in accordance with an embodiment of the present invention.

Since the computer (201) extracts the element P (i.e., the pointer value (001000) indicating the pointer, in the object X, pointing to the object Y here) from the set S in step 1705, the pointer value (001000) indicating the pointer, in the object X, pointing to the object Y is extracted from the set S. In step 1710, the computer (201) adds the pointer to the pointer field in the object Y to the set S and clears the element P (FIG. 22B). More specifically, the computer (201) adds the pointer value (011100) indicating the pointer, in the object Y, pointing to the object A to the set S and clears the element P (the pointer value (001000) indicating the pointer, in the object X, pointing to the object Y). Meanwhile, the object Y in FIG. 22A corresponds to the object Q in step 1710 of FIG. 17.

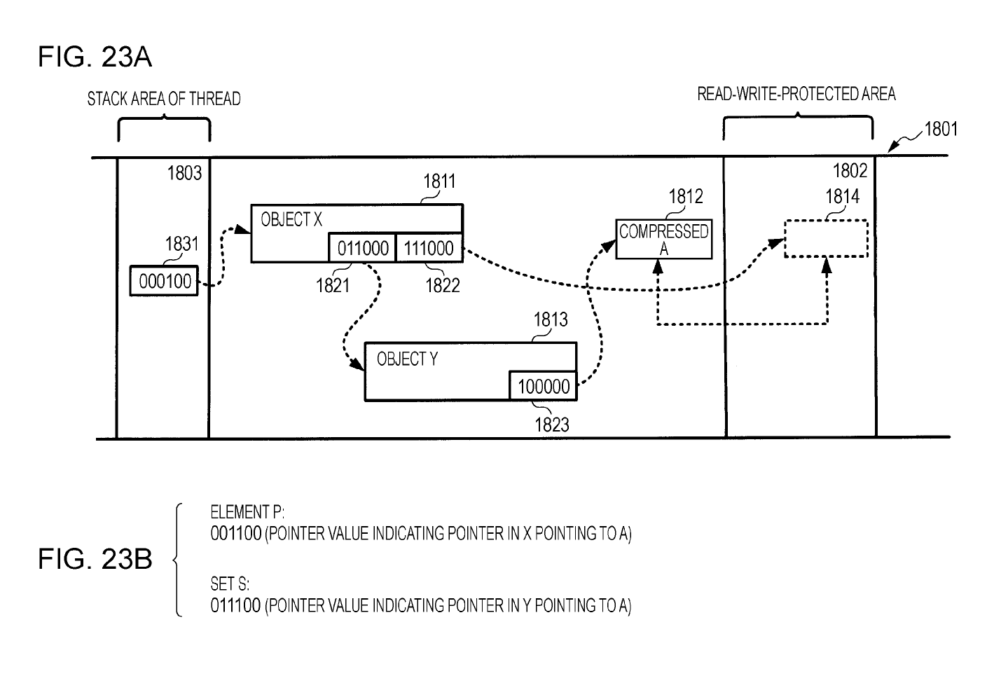

FIG. 23A illustrates a virtual address space processed in steps 1704, 1705, 1707, and 1708 of FIG. 17 in accordance with an embodiment of the present invention.

Since the computer (201) extracts the element P (i.e., the pointer value (001100) indicating the pointer, in the object X, pointing to the object A here) from the set S in step 1705, the pointer value (001100) indicating the pointer, in the object X, pointing to the object A is extracted from the set S. In step 1708, the computer (201) then rewrites the pointer (100000), in the object X, pointing to the object A (by shifting the value to the right by two bits and adding 11 to the empty bits) to convert the pointer into the barrier pointer (111000). In step 1710, the computer (201) clears the element P. Meanwhile, the object A in FIG. 23A corresponds to the object Q in step 1710 of FIG. 17.

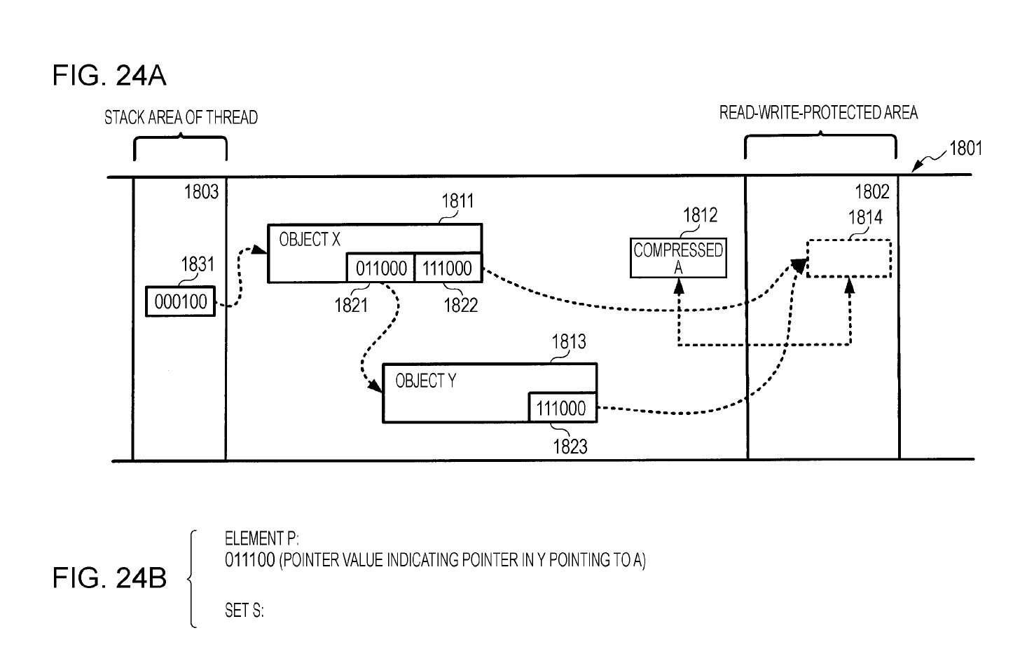

FIG. 24A illustrates a virtual address space processed in steps 1708, 1709, 1710, 1704, 1705, 1707, and 1708 of FIG. 17 in accordance with an embodiment of the present invention.

Since the computer (201) extracts the element P (i.e., the pointer value (011100) indicating the pointer, in the object Y, pointing to the object A here) from the set S in step 1705, the pointer value (011100) indicating the pointer, in the object Y, pointing to the object A is extracted from the set S. In step 1708, the computer (201) rewrites the pointer (100000), in the object Y, pointing to the object A (by shifting the value to the right by two bits and adding 11 to the empty bits) to convert the pointer into the barrier pointer (111000). In step 1710, the computer (201) clears the element P. Meanwhile, the object A in FIG. 24A corresponds to the object Q in step 1710 of FIG. 17.

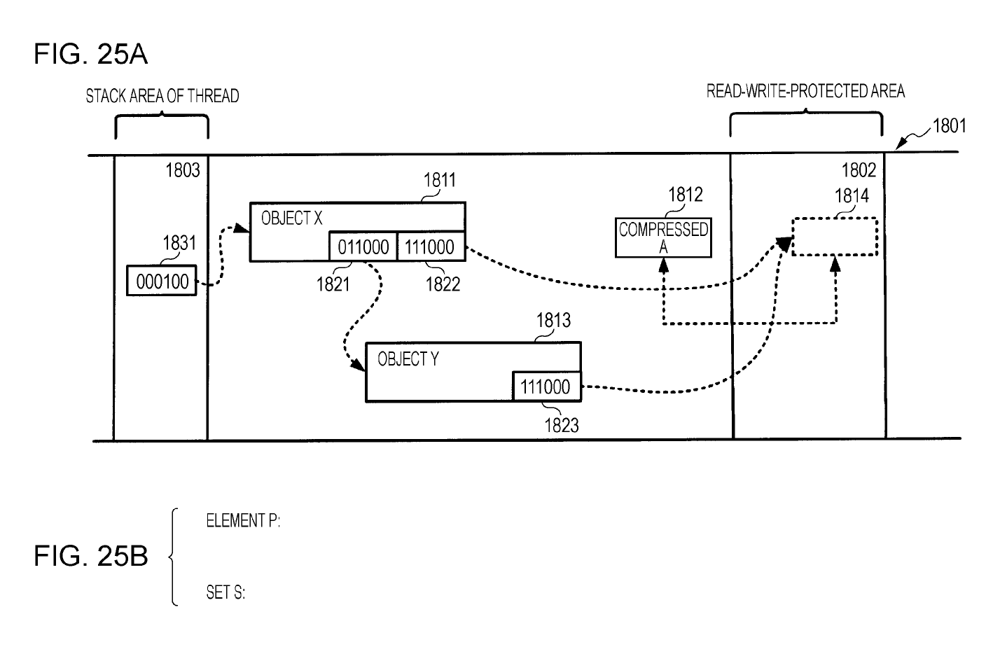

FIG. 25A illustrates a virtual address space processed in steps 1709, 1710, 1704, and 1706 of FIG. 17 in accordance with an embodiment of the present invention.

In step 1710, the computer (201) clears the element P. The process then returns to step 1704. Since the computer (201) determines that the set S includes no elements P, the process proceeds to step 1706 and terminates. FIG. 25B illustrates a virtual address space after barrierizing has completed.

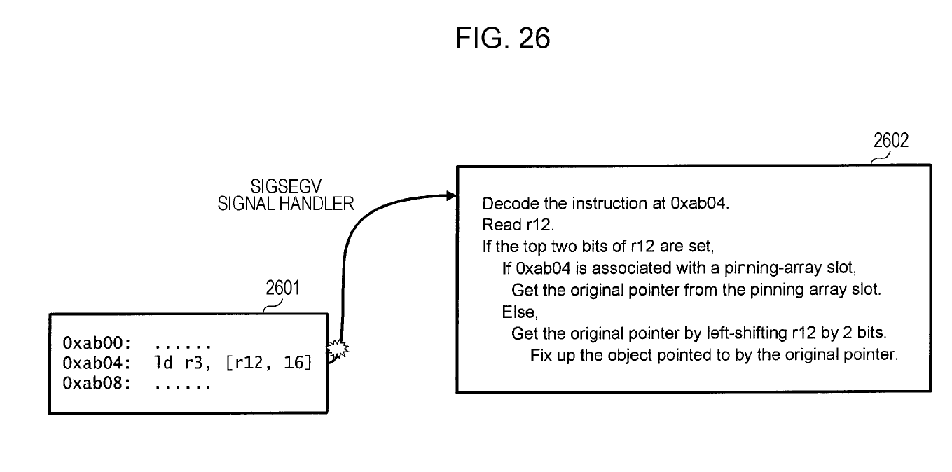

FIG. 26 illustrates an example of an operation for invoking a signal handler and recovering an original pointer from a converted pointer (reverse conversion) in accordance with an embodiment of the present invention.

SIGSEGV indicates a segmentation violation signal.

A code (2601) is a code for performing an operation indicated by a code 2602. Memory reference is expressed in a following format: [base_reg_object_head, reg_offset/imm_offset]. Additionally, access to an object (an instruction for accessing a memory of a CPU) has to be in a format “ld/st reg, [base_reg_object_head, reg/imm_offset” (load/store, load-destination register, [register including pointer value, offset]).

The code (2601) performs the operation as follows (see 2602).
Decode an instruction at 0xab04;
Read r12 to memory r3; (r12 is base_reg_object_head)
If two most-significant bits of r12 are set
   and if 0xab04 is associated with a pinning array slot,
      get the original pointer from the pinning array slot,
   and if 0xab04 is not associated with a pinning array slot,
      get the original pointer by shifting r12 to the left by two bits,

to recover the original pointer from the barrier pointer so that the object is pointed to by the original pointer.

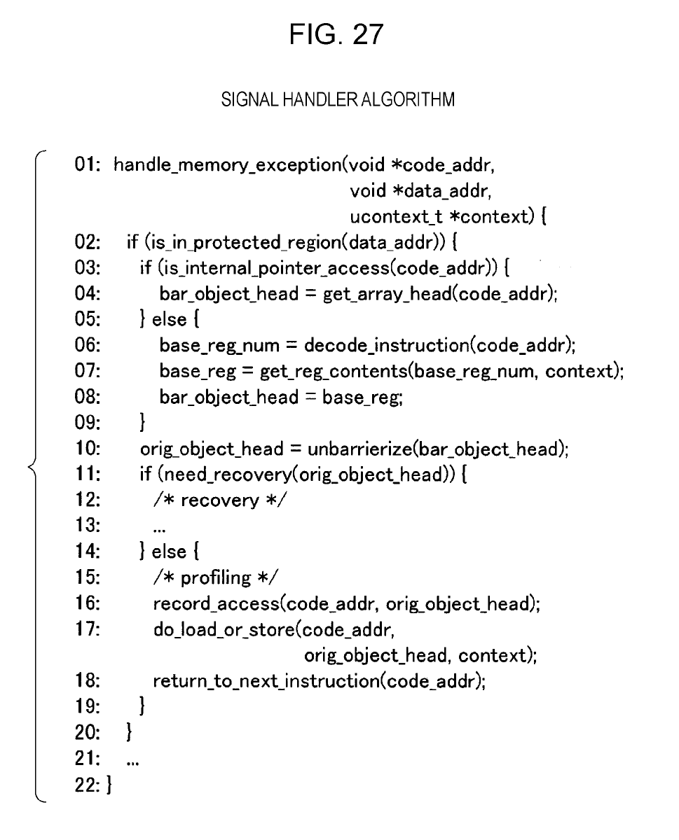

FIG. 27 illustrates an example of a signal handler process flow in accordance with an embodiment of the present invention.

Access via a barrier pointer always causes a hardware memory exception and the memory exception is converted into a signal by the operating system. The process of FIG. 27 indicates a signal handler process implemented in a Java* VM. Content of the algorithm will be described below.

(1) Recovery of Header Pointer (Reverse Conversion)

The operating system gives an exception code address, an exception data address, and signal content held in a register at the time of the hardware exception to the signal handler. The signal handler first checks whether the exception data address is in a read-write-protected area by comparing addresses (line 2). If the exception data address is in the read-write-protected area, the signal handler has to recover a pointer to a head of an object to be accessed (hereinafter, referred to as a “header pointer”). Recovery of a pointer to inside the object (hereinafter, referred to an “internal pointer”) is not sufficient because the signal handler has to refer to a header of the object in order to determine whether to execute profiling or recovery (line 11). In general, unbarrierizing the exception data address only generates an internal pointer. When the Java* VM supports a function for acquiring a header pointer from an internal pointer, this function may be used. Since the Java* VM does not generally support such a function, a format of an object access instruction has to be restricted regardless of whether the object access instruction is a code generated by a JIT compiler or an interpreter code. This indicates that a register argument of the memory register has to be the header pointer. For example, in the memory reference in the format [base_reg, offset_reg/immediate], base_reg has to be the header pointer. The signal handler then decodes the object access instruction and loads content of base_reg to the memory from the signal content, whereby the barrierized header pointer can be acquired (lines 6-8). This restriction is generally satisfied by the existing Java* VM and JIT compiler.

However, this restriction may be broken when a large object is accessed. For example, optimization of a loop resolution parameter and strength reduction in the JIT compiler may cause an internal pointer to an array. For those instructions using internal pointers, the code generated by the JIT compiler is modified in order to maintain the header pointer in a method register or a stack slot. Many JIT compilers already support this function to help the GC to traverse a root object. Without this support, the GC could not attach a mark to or move an object pointed to by an internal pointer. Additionally, the JIT compilers have to be modified in order that each instruction using an internal pointer is associated with a register number or a stack offset that stores the header pointer. This allows the signal handler to get the header pointer from the exception code address (lines 3 to 4). Since most object access instructions do not use the internal pointer, the associated data structures do not increase too much.

(2) Emulation of Object Access

After unbarrierizing the header pointer (line 10), the signal handler executes a recovery operation or profiling depending on the header of the object. Objects to be recovered have a special bit set in headers thereof. For profiling, the signal handler records access (line 16) and emulates execution of the exception instruction (line 17). For example, emulation of loading indicates that the signal handler executes loading and writes the loaded value in a target register included in the signal content instead of an exception load instruction. The signal handler is not permitted to write the unbarrierized pointer in the base register and to recover and re-execute the exception instruction. The use of this approach may cause some profile-target accesses to be missed since next instructions using the unbarrierized pointer no longer cause the hardware exception. What is worse, this approach may change semantics of the program because some of objects are expressed by two different pointer values and a pointer equality instruction is caused to return false even when two objects refer to the same object. Accordingly, the signal handler has to emulate the exception instruction.

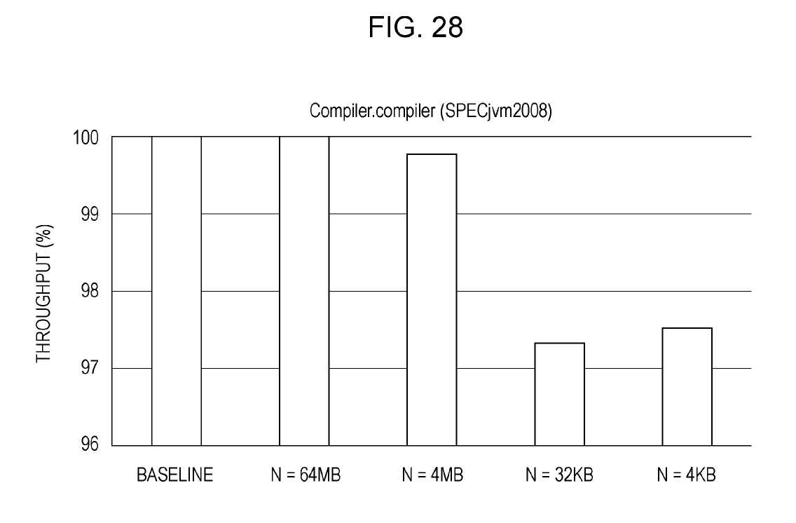

FIG. 28 illustrates a result of an experiment regarding a relation between object access frequency and overhead in accordance with an embodiment of the present invention.

A case of optimization based on an assumption that an object pointed to by a pointer is rarely accessed will be discussed. The case where the object pointed to by the pointer is rarely accessed corresponds to, for example, a case where the object is compressed (see FIG. 4) or a case where the object is lazily allocated (see FIG. 5). In a persistent object database system according to the related art, a runtime check has to be performed for every access to each object. On the other hand, in accordance with an embodiment of the present invention, only access to the object pointed to by the pointer requires overhead for exception processing. Thus, the overhead is decreased in accordance with the embodiment of the present invention.

The result of the experiment regarding the relation between access frequency to a monitoring-target object and overhead will be illustrated below.

In the experiment, one object was subjected to access monitoring every time an N-byte object was allocated. It is assumed that the monitoring target object is frequently accessed. The experiment was performed on Linux* p6 4.7 GHz×16 using IBM* ppc-32 J9/TR Java* 6 (SR6). FIG. 28 illustrates a graph of the result. The graph reveals that there is approximately 3% overhead for 32 KB or 4 KB with respect to the benchmark of compiler.compiler of standard performance evaluation corporation (SPEC) jvm2008 but there is little overhead for 64 MB or 4 MB.

Additionally, the compressed object (402) illustrated in FIG. 4 pointed to by the pointer was prepared. A benchmark program SPECjbb2005 (Java* server benchmark) was executed using the compressed object (402) on a computer implementing the method according to FIG. 14. As a result, a benchmark value of SPECjbb2005 was improved by 6.8% with the method for allocating the compressed object (402) at the time allocation.

In addition, the lazily allocated string object (502) illustrated in FIG. 5 pointed to by the pointer was prepared. A benchmark program bloat of DaCapo* benchmark was executed using the string object (502) on a computer implementing the method according to FIG. 14. As a result, the “bloat” benchmark is speeded up by 6% in the case of the string object (502).

In the above, the case of optimization based on the assumption that the object pointed to by the pointer is rarely accessed has been discussed. However, when the object pointed to by the pointer is frequently accessed, the object is not subjected to compression or lazy allocation in the first place. Additionally, an access location of the object can be known using the embodiments of the present invention when the object pointed to by the pointer is frequently accessed. This is because, as indicated by step 1503 of FIG. 15, an instruction address where an exception has occurred can be known and the address indicates the access location of the object. Accordingly, only a runtime check has to be performed on the access location after the JIT compiler recompiles the program.

1. A method for detecting access to an object in processing in a computer, the method comprising the steps, performed by at least one processor of the computer, of:
converting an original pointer to the object into a manipulated pointer pointing to a read-write-protected area by manipulating the original pointer; and
reversely converting the converted pointer into the original pointer using occurrence of an exception in response to a request to access the read-write-protected area.

2. The method according to claim 1, wherein the step of reversely converting includes:
a step of acquiring, with reference to an instruction that has caused the exception, the manipulated pointer from the instruction that has caused the exception; and
a step of reversely converting the manipulated pointer and acquiring a pointer to a head of the object pointed to by the reversely converted original pointer.

3. The method according to claim 2, further comprising the step, performed by at least one processor of the computer, of:
performing processing suitable for a format of the object pointed to by the reversely converted original pointer with reference to header information of the object pointed to by the reversely converted original pointer.

4. The method according to claim 3, further comprising the step, performed by at least one processor of the computer, of:
accessing the object pointed to by the reversely converted original pointer after performing the processing suitable for the format.

5. The method according to claim 3, wherein processing suitable for the format includes decompression of a compressed object or lazy allocation of a character array.

6. The method according to claim 1, wherein the step of converting includes a step of acquiring the pointer pointing to the read-write-protected area by adding a certain offset value to the original pointer.

7. The method according to claim 6, wherein the step of reversely converting includes a step of acquiring the original pointer by subtracting the certain offset value from the converted pointer.

8. The method according to claim 1, wherein the step of converting includes a step of acquiring the pointer pointing to the read-write-protected area by shifting the original pointer to the object to the right by n bits (where n is an integer) and adding a certain offset value to the right-shifted pointer.

9. The method according to claim 8, wherein the step of reversely converting includes a step of acquiring the original pointer by subtracting the certain offset value from the converted pointer and shifting the subtracted pointer to the left by the n bits.

10. The method according to claim 1, wherein the read-write-protected area is a protected area of an operating system.

11. The method according to claim 1, wherein the step of converting includes a step of acquiring the pointer pointing to the read-write-protected area by shifting the original pointer to the object to the right by n bits (where n is an integer) and embedding an address of the read-write-protected area in empty most-significant bits.

12. The method according to claim 11, wherein the step of reversely converting includes a step of acquiring the original pointer by shifting the converted pointer to the left by the n bits.

13. The method according to claim 1, wherein the step of reversely converting includes:
a step of acquiring, with reference to a correspondence table of an instruction address where the exception has occurred and a register or slot number of a slot storing a pointer value to a head of an object, the manipulated pointer from the instruction address where the exception has occurred; and
a step of reversely converting the acquired pointer and acquiring a pointer to the head of the object pointed to by the reversely converted original pointer.

14. The method according to claim 1, wherein the step of converting is performed in object allocation or garbage collection.

15. The method according to claim 1, wherein occurrence of the exception is occurrence of segmentation violation.

16. The method according to claim 1, wherein a signal handler is started in response to occurrence of the exception and the step of reversely converting is executed with the signal handler.

17. A computer that detects access to an object, the computer comprising:
a conversion unit that converts an original pointer to the object into a converted pointer pointing to a read-write-protected area by manipulating the original pointer; and
a reverse conversion unit that reversely converts the converted pointer into the original pointer using occurrence of an exception in response to a request to access the read-write-protected area.

18. The computer according to claim 17, wherein the reverse conversion unit further acquires, with reference to an instruction that has caused the exception, the converted pointer from the instruction that has caused the exception, reversely converts the acquired pointer, and acquires a pointer to a head of the object pointed to by the reversely converted original pointer, and
wherein the computer further comprises:
a processing unit that performs processing suitable for a format of the object pointed to by the reversely converted original pointer with reference to header information of the object pointed to by the reversely converted original pointer.

19. The computer according to claim 18, further comprising:
an execution unit that accesses the object pointed to by the reversely converted original pointer after processing suitable for the format is performed.

20. A computer program medium storing a program of instructions for causing at least one processor of a computer to perform method steps for detecting access to an object in processing in a computer, the method comprising the steps of:
converting an original pointer to the object into a manipulated pointer pointing to a read-write-protected area by manipulating the original pointer; and
reversely converting the converted pointer into the original pointer using occurrence of an exception in response to a request to access the read-write-protected area.
